(19) United States
(12) Patent Application Publication
(10) Pub. No.: US 2014/0022195 A1
(43) Pub. Date: Jan. 23, 2014

(54) TOUCH SCREEN INFORMATION SYSTEM

(71) Applicant: MediaUSA Advertising, Inc., Litchfield, MN (US)

(72) Inventor: Mark W. Lease, Litchfield, MN (US)

(21) Appl. No.: 13/946,691

(22) Filed: Jul. 19, 2013

Related U.S. Application Data
(60) Provisional application No. 61/673,404, filed on Jul. 19, 2012.

(51) Int. Cl. G06Q 50/12; G06Q 10/00

(52) U.S. Cl. CPC G06Q 50/12; G06Q 10/00
USPC 345/173

(57) ABSTRACT

A touch screen information system provides guests or users of a hotel or business with information. The touch screen information system includes system memory which stores an operating system, programming modules and program data. A touch screen display device is configured to provide a viewable area, capable of receiving a user input in the form of a touch, which includes a guest information display area and an operating system and administrative display area. A bezel covers the operating system and administrative display area of the viewable area of the touch screen display device to prevent access to the operating system and administrative display area by guests or users of the hotel or business, but allows access to the guest information display area by the guests or users of the hotel or business. A processor is operably coupled to the system memory and to the touch screen display device such that the processor is configured with the operating system, programming modules and program data to control the touch screen display device to provide information to the guests or users of the hotel or business by displaying the information in the guest information display area.

### CROSS-REFERENCE TO RELATED APPLICATION

The present application is based on and claims the benefit of U.S. provisional patent application Ser. No. 61/673,404, filed Jul. 19, 2012, the content of which is hereby incorporated by reference in its entirety.

### FIELD

Disclosed embodiments relate to touch screen information systems which can be provided in lobbies of hotels or in other locations to provide guests or users with a source of information on local businesses, activities and the like.

### BACKGROUND

Business or vacation travelers visiting an area with which they are not familiar typically require assistance discovering options for dining, shopping, entertainment, etc. Frequently, a concierge is employed by a hotel to advise guests of dining, shopping or entertainment options, and to help the guests stay informed of travel (e.g., airline departures, etc.) arrangements or other information. However, a concierge may have limited knowledge and information on area businesses, airline schedules, directions to businesses, etc. Further, a concierge must be paid by the hotel and thus is a significant expense in some instances.

Providing information to guests via computers or displays is known, and represents an attempt to improve the guest's experience and to potentially reduce the costs associated with employing one or more concierges. However, providing a large amount of information to a guest can be challenging. Prior attempts have provided relatively limited amounts of information, and have not presented the information to the user in as useful a format as would be liked. Further, providing such information can itself be costly.

When providing information to guests using a computer in a public or semi-public setting, a risk exists that an unauthorized user will access inappropriate material over the internet using the computer. For example, a user could access inappropriate images and leave those inappropriate images displayed where guests, possibly including children, will see those images. For this reason, using computers to provide information to guests or users in these settings must be tightly controlled.

The discussion above is merely provided for general background information and is not intended to be used as an aid in determining the scope of the claimed subject matter.

### SUMMARY

This summary and the abstract are provided to introduce a selection of concepts in a simplified form that are further described below in the Detailed Description. The summary and the abstract are not intended to identify key features or essential features of the claimed subject matter, nor are they intended to be used as an aid in determining the scope of the claimed subject matter.

A touch screen information system provides guests or users of a hotel or business with information. The touch screen information system includes system memory which stores an operating system, programming modules and program data. A touch screen display device is configured to provide a viewable area, capable of receiving a user input in the form of a touch, which includes a guest information display area and an operating system and administrative display area. A bezel covers the operating system and administrative display area of the viewable area of the touch screen display device to prevent access to the operating system and administrative display area by guests or users of the hotel or business, but allows access to the guest information display area by the guests or users of the hotel or business. A processor is operably coupled to the system memory and to the touch screen display device such that the processor is configured with the operating system, programming modules and program data to control the touch screen display device to provide information to the guests or users of the hotel or business by displaying the information in the guest information display area.

### BRIEF DESCRIPTION OF THE DRAWINGS

FIG. 1 is a block diagram illustration of a computing device or system in which the touch screen information system of disclosed embodiments is embodied in example embodiments.

FIG. 2 is a diagrammatic illustration of the touch screen display of the system of FIG. 1 in accordance with certain exemplary disclosed embodiments.

FIG. 3 is an illustration of a first or home screen of a user interface (UI) showing a guest information display area.

FIG. 4 is an illustration of the UI when the user touches a dining input on the display.

FIG. 5 is an illustration of the UI in the dining category configuration of FIG. 4, but after one of the advertisement icons has been touched by a user.

FIG. 6 illustrates the UI with a pop-up window opened in response to a user touching a “VIEW MENU” input on the display.

FIG. 7 is an illustration of the UI illustrating a pop-up window opened after a user touches a “DIRECTIONS” input.

FIG. 8 is an illustration of the UI illustrating a pop-up window displayed when the user wishes to have directions sent via text message to his or her phone.

FIG. 9 is an illustration of the UI illustrating a pop-up window displayed when the user wishes to have directions sent via email.

FIG. 10 is an illustration of the UI in the dining category configuration of FIG. 4, but after one of the side advertisements has been touched by a user.

FIGS. 11-14 are illustrations of UI screens which can be navigated to from the screen shown in FIG. 10.

FIGS. 15 and 16 illustrate the UI after an airport flight information icon or button has been touched by a user.

FIGS. 17-19 illustrate the UI after a hotel and events information icon or button has been touched by a user.

FIG. 20 illustrates the UI after an airport flight local weather window has been touched by a user.

FIG. 21 illustrates embodiments in which the UI includes a FIND IT feature implemented by the touch screen information system.

FIGS. 22 and 23 illustrate the UI with pop-up windows used to implement the FIND IT feature.

FIG. 24 is an illustration of an alternate configuration of the first or home screen of the UI shown in FIG. 3 in which slightly different categories are used.

FIG. 25 is an illustration of the UI of FIG. 24 in response to a user touching an “OTHER DINING” input.

FIG. 26 is an illustration of the UI when a user touches an input corresponding to a particular dining establishment in the UI shown in FIG. 25.

FIG. 27 is an illustration of the UI in FIG. 26 illustrating a pop-up window displayed when the user wishes to have directions sent via text message to his or her phone.

FIG. 28 is an illustration of the UI in FIG. 26 illustrating a pop-up window displayed when the user wishes to have directions sent via email.

FIG. 29 illustrates a more detailed weather window in accordance with some exemplary embodiments.

FIG. 30 is an illustration of a first or home screen of the UI in an exemplary embodiment which is not based on, and does not include, advertisements from paid advertisers.

FIG. 31 is an illustration of the UI of FIG. 30 with pop-up windows displayed in response to a user touching a HOTEL EVENTS & INFO input.

FIGS. 32 and 33 are illustrations of the UI of FIG. 30 with a pop-up window displayed in response to a user touching a FIND IT input.

FIG. 34 is an illustration of the UI of FIG. 30 with a more detailed weather window displayed in response to a user touching a WEATHER input.

FIGS. 35-38 are illustrations of the UI of FIG. 30 with pop-up windows displayed in response to a user touching an AIRPORT INFO input.

FIGS. 39-40 are illustrations of the UI of FIG. 30 with pop-up windows displayed in response to a user touching a VISITOR SERVICES input.

FIGS. 41-42 are illustrations of the UI of FIG. 30 with pop-up windows displayed in response to a user touching a FOOD & DRINK input.

FIGS. 43-44 are illustrations of the UI of FIG. 30 with pop-up windows displayed in response to a user touching a THINGS TO DO input.

FIG. 45 is an illustration of the UI of FIG. 30 with a pop-up window displayed in response to a user touching a SPA & SALON input.

FIG. 46 is an illustration of the UI of FIG. 30 with a pop-up window displayed in response to a user touching a SHOPPING input.

FIG. 47 is an illustration of the UI of FIG. 30 with a pop-up window displayed in response to a user touching a NIGHT LIFE input.

### DETAILED DESCRIPTION OF ILLUSTRATIVE EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected,” “coupled” and variations thereof are used broadly and encompass both direct and indirect connections and couplings. Further, “connected” and “coupled” are not restricted to physical or mechanical connections or couplings.

Exemplary embodiments of the disclosed invention preferably operate in a suitably programmed computer with a large touch screen display. However, disclosed embodiments can be in other computing environments such as those which use a large display, but not of the touch screen variety.

Although not required, the invention is described in the general context of computer-executable instructions, such as program modules, being executed by an electronic device. Generally, program modules include routines, programs, objects, components, data structures, etc. that perform particular tasks or implement particular abstract data types. In embodiments, the invention may be practiced in distributed computing environments where tasks are performed by remote processing devices that are linked through a communications network. In a distributed computing environment, program modules may be located in both local and remote memory storage devices.

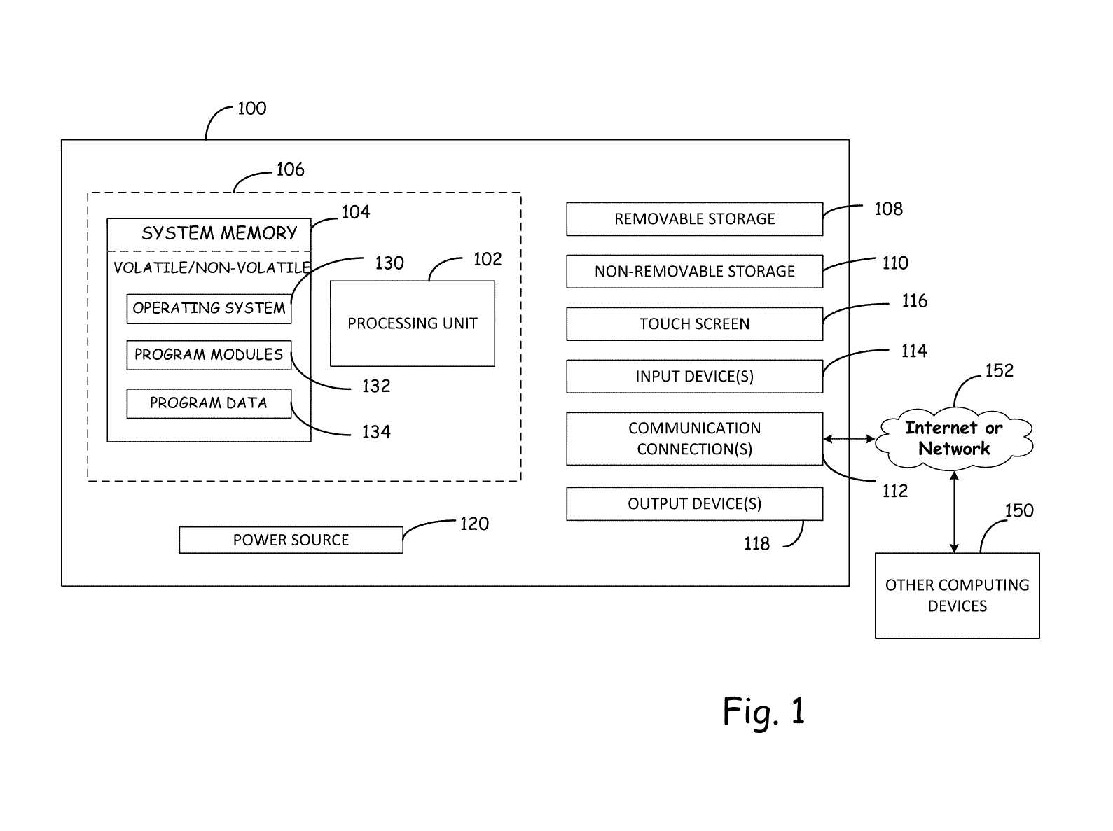

FIG. 1 shows an exemplary device 100 for implementing an embodiment of the invention. In its most basic configuration, the computing device 100 includes at least a processing unit 102 and a memory 104. Depending on the exact configuration and type of computing device, the memory 104 may be volatile (such as RAM), non-volatile (such as ROM, flash memory, etc.) or some combination of the two. This most basic configuration is illustrated in FIG. 1 by a dashed line 106.

Additionally, the device 100 may also have additional features/functionality. For example, the device 100 may also include additional storage (removable and/or non-removable) including, but not limited to, magnetic or optical disks or tapes, USB flash drives, memory cards, etc. Such additional storage is illustrated in FIG. 1 by a removable storage 108 and a non-removable storage 110. Computer storage media includes volatile and nonvolatile, removable and non-removable media implemented in any method or technology for storage of information such as computer readable instructions, data structures, program modules or other data. The memory 104, the removable storage 108 and the non-removable storage 110 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can accessed by the device 100. Any such computer storage media may be part of the device 100. In disclosed embodiments, some or all of the operating system, the program modules and/or the program data used to configure a processor to implement embodiments of the user interface can be stored in non-volatile memory associated with the processor, can be accessed via the internet or other network from other websites, or can be accessed by the processor from a combination of non-volatile memory and websites. The operating system, the program modules and the program data would all be stored at least temporarily in volatile system memory associated with and accessed by the processor.

In the description that follows, the invention will be described with reference to acts and symbolic representations of operations that are performed by one or more devices, unless indicated otherwise. As such, it will be understood that such acts and operations, which are at times referred to as being computer-executed, include the manipulation by the processing unit of the device of electrical signals representing data in a structured form. This manipulation transforms the data or maintains it at locations in the memory system of the device, which reconfigures or otherwise alters the operation of the device in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

System memory 104 may include operating system 130, one or more programming modules 132, and program data 134. Operating system 130, for example, may be suitable for controlling computing device 100's operation. In one embodiment, programming modules 132 may include visual feedback and user interface (UI) generating and controlling applications which provide a UI having one or more of the features described below. Furthermore, embodiments of the invention may be practiced in conjunction with a graphics library, other operating systems, or any other application program and is not limited to any particular application or system. As stated above, a number of program modules 132 and data files 134 may be stored in system memory 104, including operating system 130. While executing on processing unit 102, programming modules 132 may perform processes including, for example, one or more methods required or useful to generate and control a UI as described below.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The device 100 may also contain one or more communications connections 112 that allow the device to communicate with other devices. The communications connections 112 can include, for example, wired media connections such as a wired network or direct-wired connection, and wireless media connections such as acoustic, RF, infrared and other wireless media connections. In exemplary embodiments, communications connections 112 are configured to provide communication between device 100 and other computing devices 150 over a computer network 152 such as the internet.

The device 100 preferably has a touch screen input and display 116 that is actuatable by a user's finger. The device 100 may also have one or other more input devices 114 such as a keyboard, mouse, pen, voice input device, etc. The device 100 may also have one or more other output devices 118 such as speakers, a printer, a vibration generator, etc. All these devices are well known in the art and need not be discussed at greater length here. The device 100 can be provided with a portable OR non-portable power source 120, such as a battery pack, a transformer, a power supply, or the like. The power source 120 provides power for computations, display, communications and so forth by the device 100.

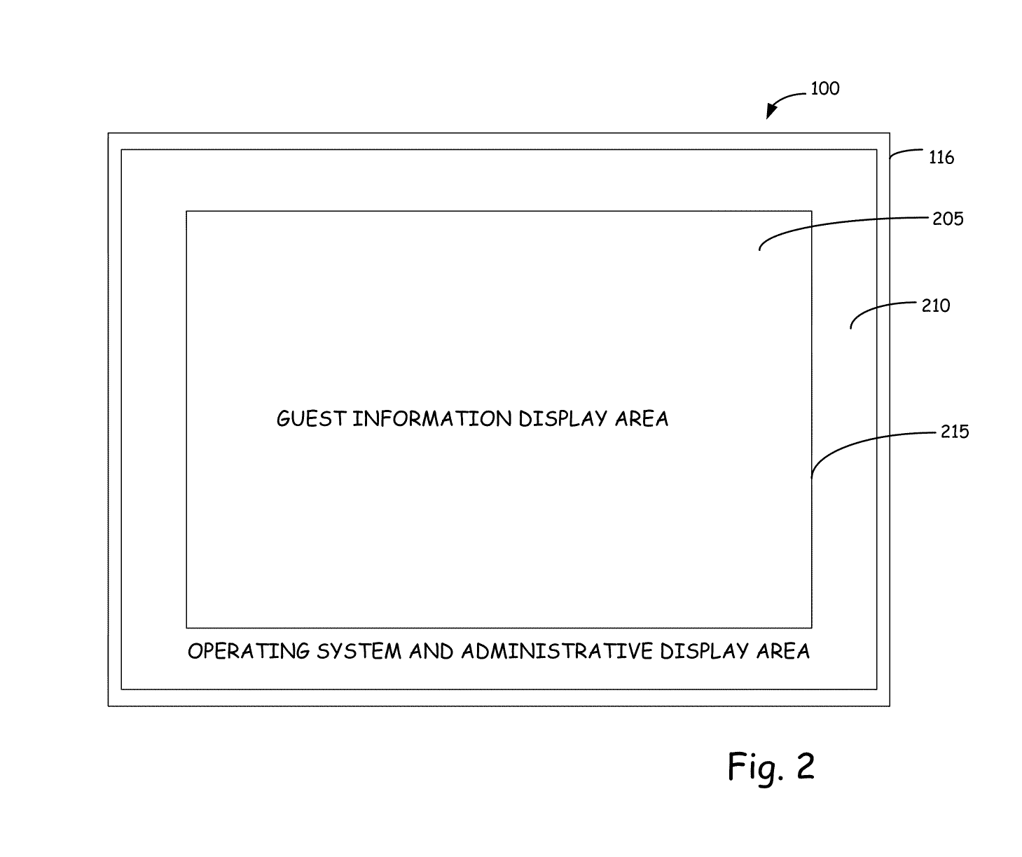

Referring now to FIG. 2, shown is a diagrammatic illustration of touch screen display 116 in accordance with some exemplary embodiments. Touch screen display 116 has a viewable area, capable of receiving user input in the form of a touch, which includes guest information display area 205 and operating system and administrative display area 210. Generally, operating system and administrative display area 210 will occupy one or more outer portions of the touch screen display viewable area which correspond to locations of operating system controls. For example, area 210 occupies, in some embodiments, display areas where an operating system “Start” button, an operating system task bar, and the like would be positioned. Guest information display area 205 generally occupies at least the inner portions of the touch screen display viewable area.

In these exemplary embodiments, a bezel 210 covers the operating system administrative display area when touch screen display 116 is made available for use by guests of a hotel or business in which device or system 100 and touchscreen display 116 are located. Thus, a guest can be prevented from accessing operating system controls, web browsers or other features that would allow the guest to disrupt operation of the device 110 and display 116, access inappropriate content, etc. The aforementioned program modules and program data configure processing unit 102, which can include multiple separate processors and/or a dedicated display processor, to generate the UI disclosed below in guest information display area 205. While bezel 210 is shown in an exemplary embodiment to be of substantially identical width near the entire perimeter of touchscreen display 116, in other embodiments operating system display area 210 is more limited, for example to the bottom and/or one side of the display. In these embodiments, bezel 210 can be sized and shaped accordingly to provide access to as much display area as desired for providing guest information display area, and need not be of uniform width around the perimeter. In exemplary embodiments, bezel 210 can be removed by an administrator, owner or operator of touchscreen display 116 and device 100 if and when access to the operating system is required. Further, remote access to the operating system can be achieved from another computing device via internet or network 152 without removing the bezel.

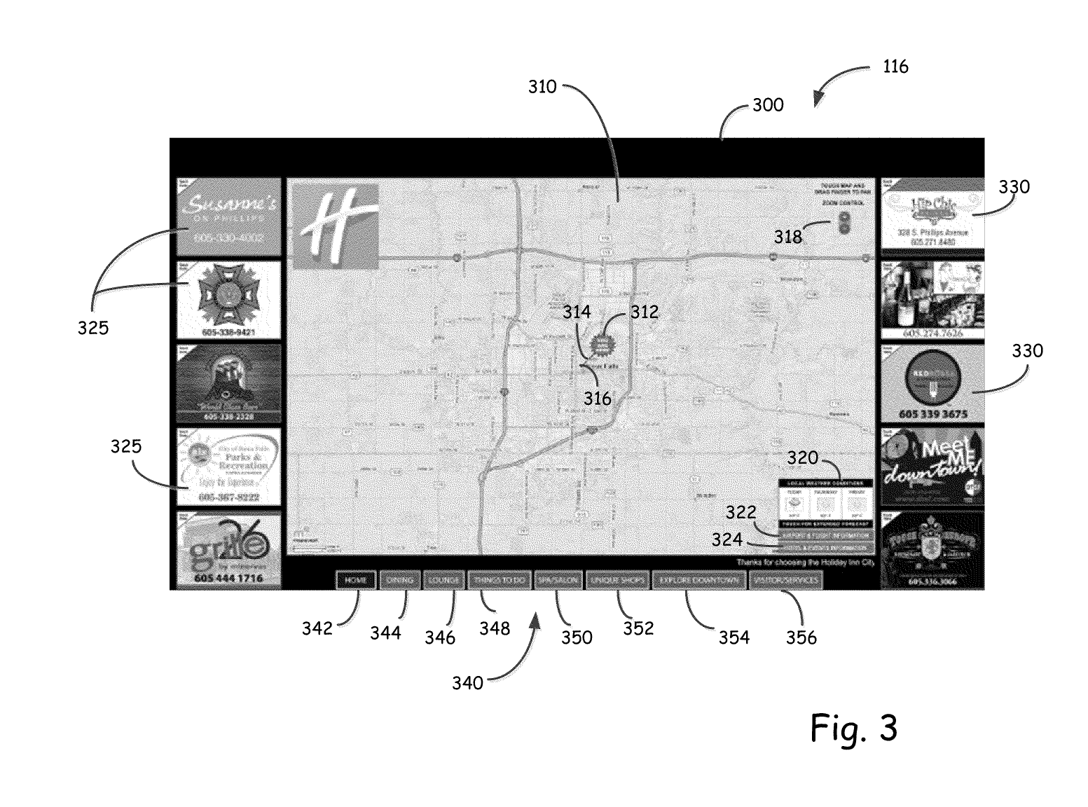

Referring now to FIG. 3, shown is a first or home screen of a UI 300 which device 100 is configured or configurable to generate in guest information display area 205 of touchscreen display 16. The UI 300 includes a map 310 showing an area surrounding the location of the hotel, business or other establishment at which the display 116 is physically located. A “YOU ARE HERE” icon or symbol 312 is generated and attached to a point 316 on the map by a generated connecting line 314. The point represents the physical location of the display 116 (and therefore of the guest or user). As is the case with other physical location identifying icons, symbols, logos or designators described throughout this disclosure, a user can touch the symbol (e.g., 312) and drag it to a different location in order to improve the view of features on the map. When doing so, the corresponding point (e.g., 316) does not move, and the connecting line (e.g., 314) rotates about the point (e.g., 316) as is required to maintain the connection between the symbol and the point.

Also shown overlaid on map 310 is a zoom control input 318 which allows the guest or user to zoom the map view in or out to see either more detail or a larger region. A local weather window 320 is also displayed on top of map 310. The local weather information is automatically updated from a source of weather information, for example a subscription source, over network or internet connection 152. Also displayed on UI 116 under the weather window 320 is an airport flight information icon or button 322 and a hotel and events information icon or button 324. Buttons 322 and 324, when touched by a user, cause the UI to display additional pop-up windows which are described later in additional detail with reference to other Figs.

On the sides of the home screen UI are multiple, in this case ten, large advertisements for local businesses. In this embodiment, there are five left side advertisements 325 and five right side advertisements 330. The businesses typically pay for the advertisements, allowing the touch screen information to be provided to guest at little or no cost to the guests or to the hosting hotel or business. In some embodiments, each time a guest or user touches the display 116 the selection of advertisements changes and is updated from a pool of all advertising businesses.

On the bottom of the home screen UI is a bar or row 340 including multiple selectable buttons or user inputs which can be touched by a user to cause device 100 to open different pop-up up windows to obtain additional information for a particular category of inquiry. For example, besides “HOME” input 342, UI 300 can include a “DINING” input 344, “LOUNGE” input 346, “THINGS TO DO” input 348, “SPA/SALON” input 350, “UNIQUE SHOPS” input 352, “EXPLORE DOWNTOWN” input 354 and “VISITOR SERVICES” INPUT 356. Other or different types of categories can also be used. The following disclosure describes the UI features which device 100 is configured to render on display 116 in response to certain exemplary inputs. Other inputs, not described in detail separately, result in similar UI features and information being displayed.

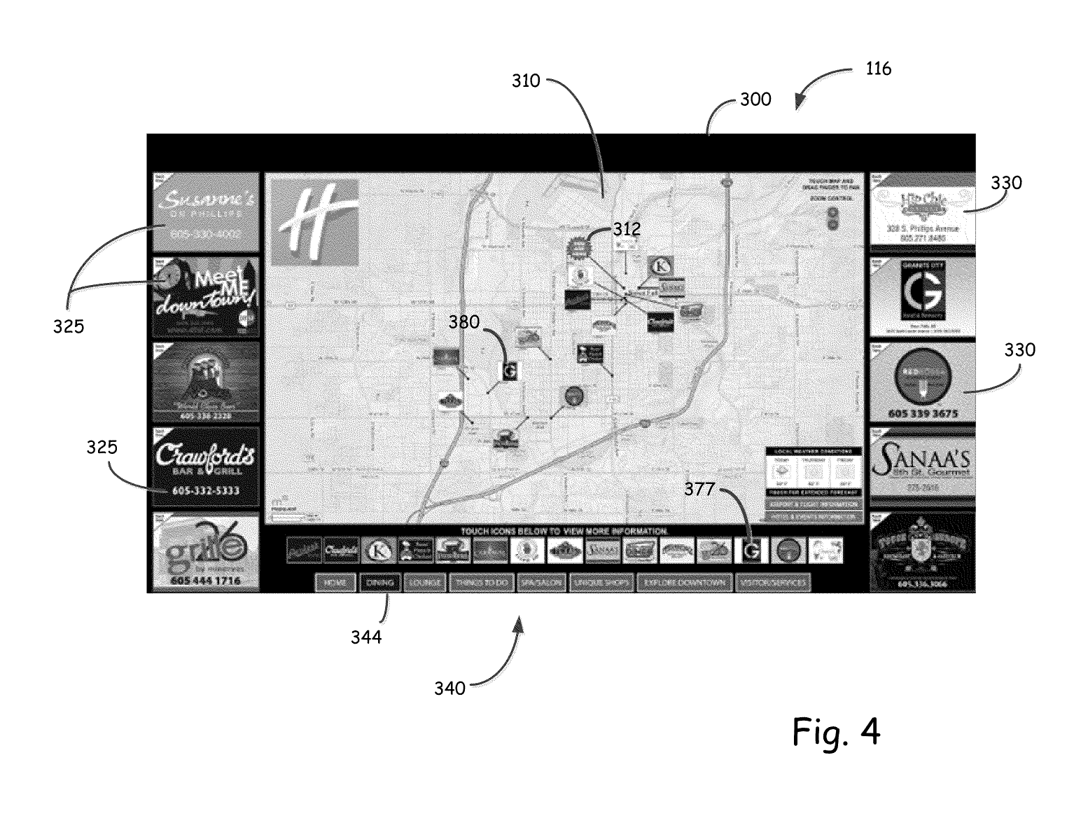

Referring now to FIG. 4, shown is UI 300 when a user touches dining input 344 on display 116. After touching dining input 344, a row 375 of restaurant category icons 377 is generated above bar 340 of selectable user inputs. The icons each correspond to a different restaurant in the area that has paid to purchase advertising space on the touch screen information system. Also, after touching dining input 344, a location pinned icon 380 for each of the restaurants in row 375 is generated on top of map 310. As was the case with “YOU ARE HERE” icon 312, each restaurant icon 380 is associated with a pinned location of the restaurant by a generated line such that a user can move the restaurant icon by touching the screen and dragging the icon, while the visual association with the pinned location of the restaurant is maintained. In this screen of UI 300, the side advertisements 325 and 330 continue to be displayed for multiple different advertisers while row 375 of icons is displayed.

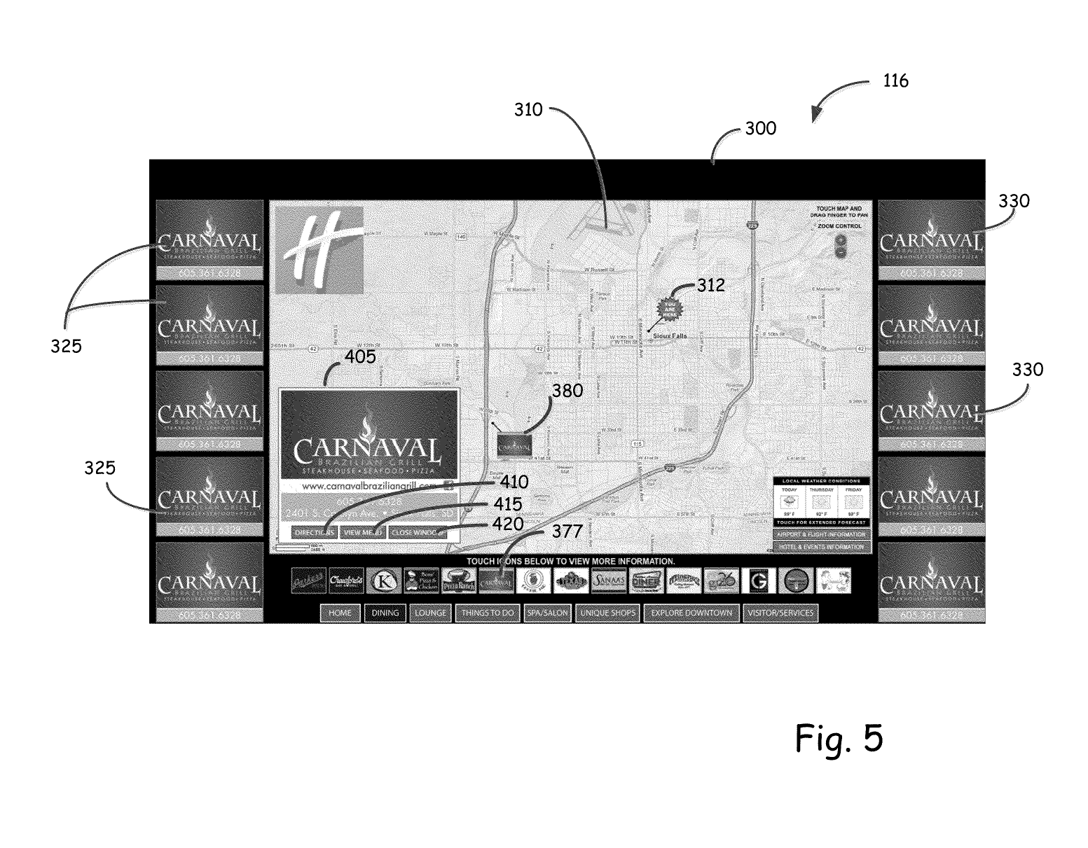

Referring now to FIG. 5, shown is UI 300 in the dining category configuration of FIG. 4, but after one of the advertisement icons 377 in row 375 has been touched by the guest or user. In this instance, all side advertisements 325 and 330 change to be advertisements for that one selected business. However, in one exemplary embodiment, row 375 showing advertising icons for various other businesses in the selected category is still displayed.

Also, after touching the advertisement for a restaurant in the dining category, a pop-up box or window 405 is displayed providing additional information for the restaurant. In the illustrated embodiment, the additional information can include a phone number, a street address and/or a website URL. Also included in the pop-up box or window is a “DIRECTIONS” input 410, a “VIEW MENU” input 415, and a “CLOSE WINDOW” input 420. Further, UI 300 is configured such that, after touching the advertisement for a restaurant in the dining category, only the restaurant icon 380 for the selected restaurant remains pinned to map 310 (along with “YOU ARE HERE” icon 312). The pinned location icons for the other restaurants are not displayed at this point.

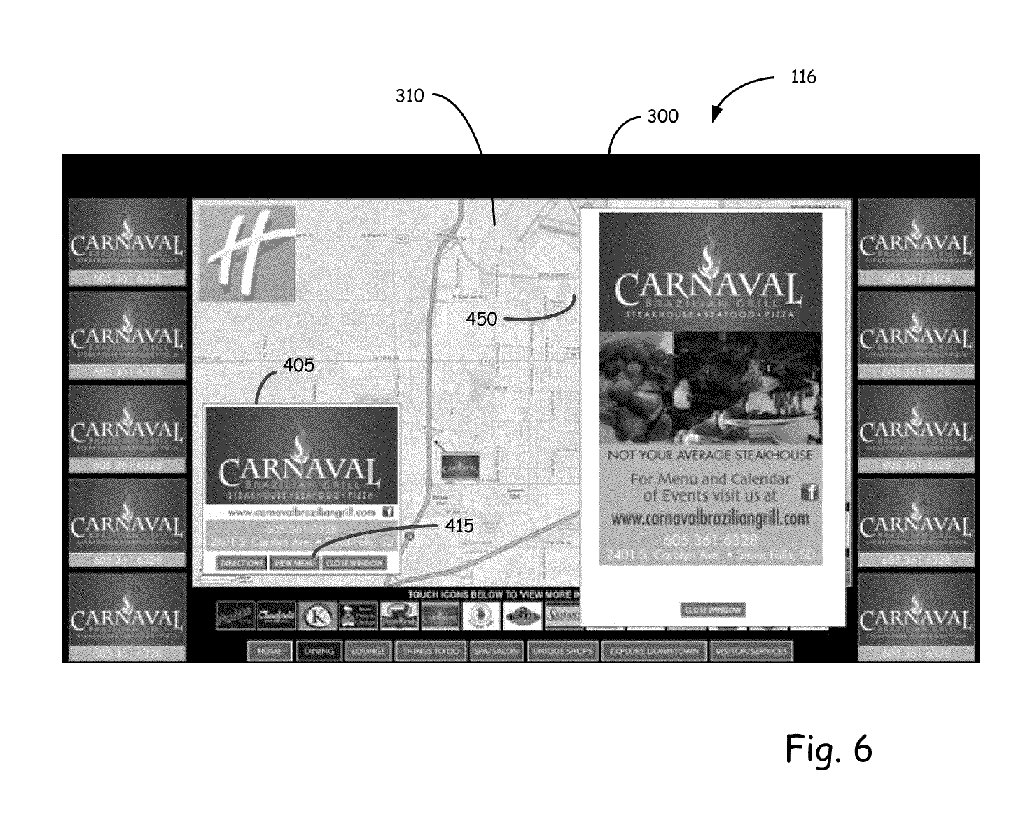

When a user touches “VIEW MENU” input 415, another pop-up window 450 (shown in FIG. 6) opens. Window 450 either displays the menu for the selected restaurant, or provides additional information on where a menu can be viewed. Other information can also be provided in pop-up window 450, such as repeating web site information, a phone number, an address, etc.

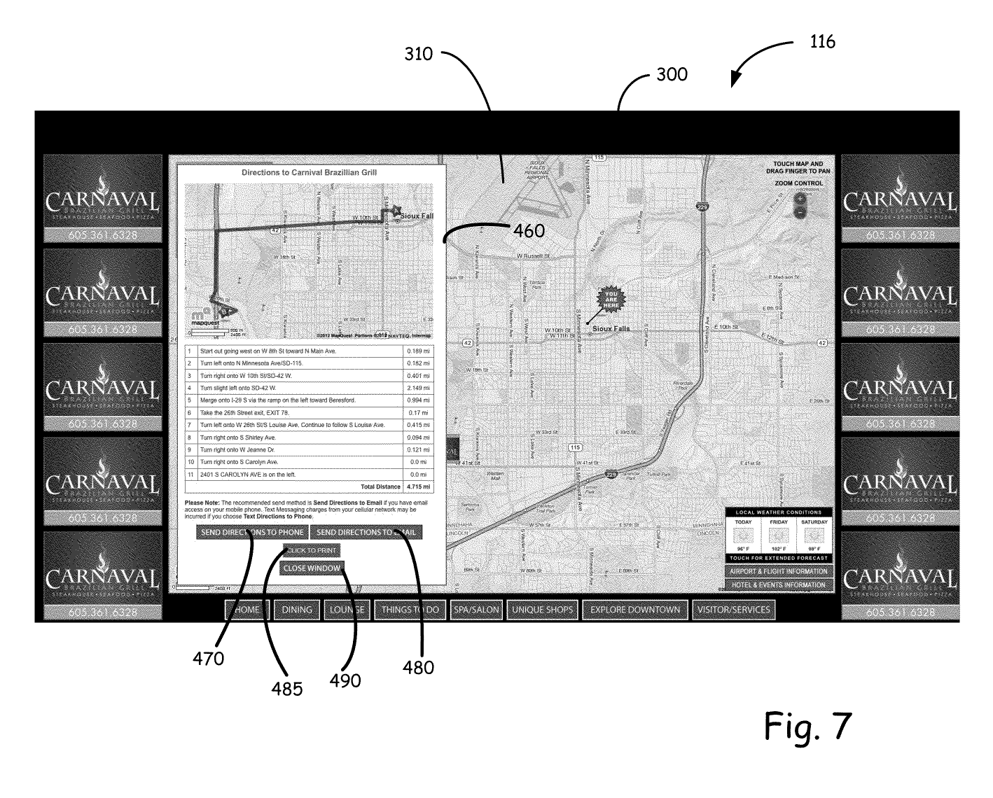

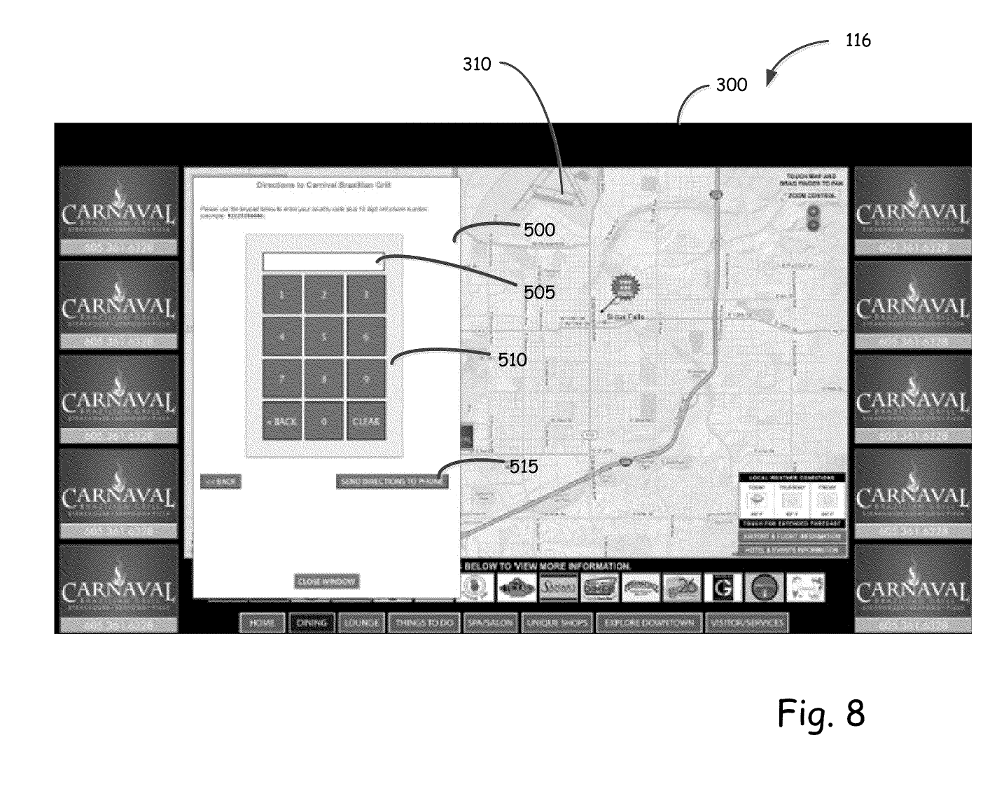

When a user touches “DIRECTIONS” input 410, a pop-up window 460 opens as shown in FIG. 7. In window 460, turn by turn driving directions between the guest's current location (e.g., the hotel) and the restaurant are illustrated. In some embodiments as shown, a map is also illustrated in window 460. Window 460 also includes a “SEND DIRECTIONS TO PHONE” input 470, a “SEND DIRECTIONS TO EMAIL” input 480, a “CLICK TO PRINT” input 485 and a “CLOSE WINDOW” input 490. If a user wishes to have the directions sent via text message to his or her phone they touch input 470 and a pop-up window 500 is displayed on the UI as shown in FIG. 8. Window 500 includes a number input field 505 where inputted numerals of the phone number are displayed, a touch keypad 510 for inputting the numerals, and another “SEND DIRECTIONS TO PHONE” input 515. After inputting the user's cell phone number, touching input 515 results in the turn by turn driving directions being texted to the user's phone.

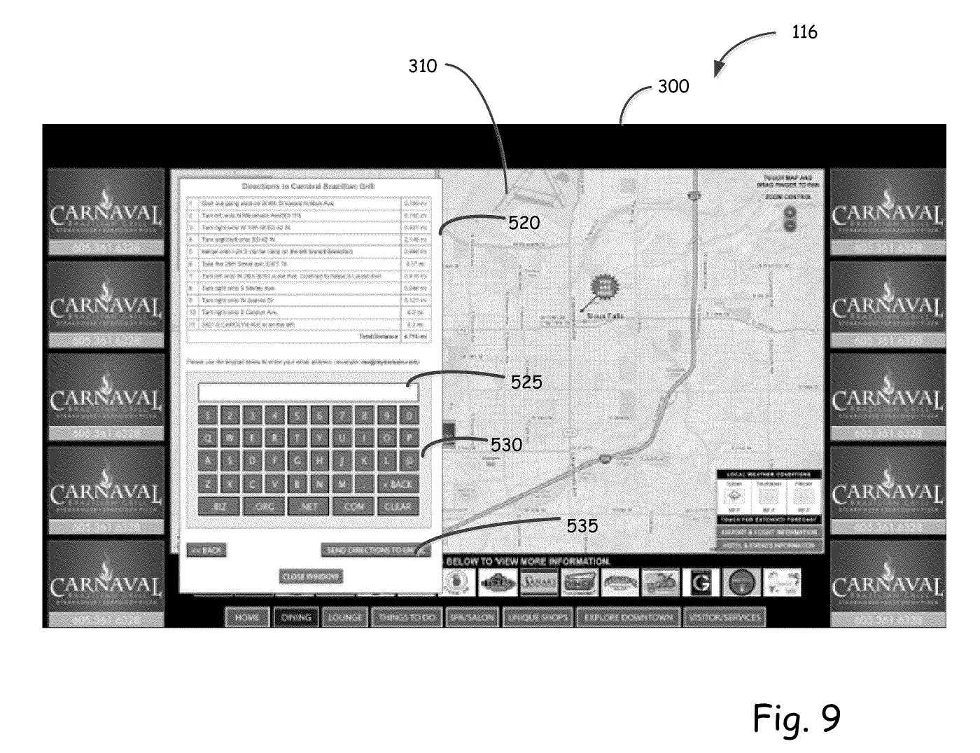

If a user wishes to have the directions sent via email, he or she touches input 470 and a pop-up window 520 is displayed on the UI as shown in FIG. 9. Window 520 includes a character input field 525 where inputted characters of an email address are displayed, a touch keyboard 530 for inputting the characters of the email address, and another “SEND DIRECTIONS TO EMAIL” input 535. After inputting the user's email address, touching input 535 results in the turn by turn driving directions being sent via email to the user. If a user wishes to print the directions to a printer connected to device or system 100, either directly or through a network, this task is implemented by the system upon touching the “CLICK TO PRINT” input 485.

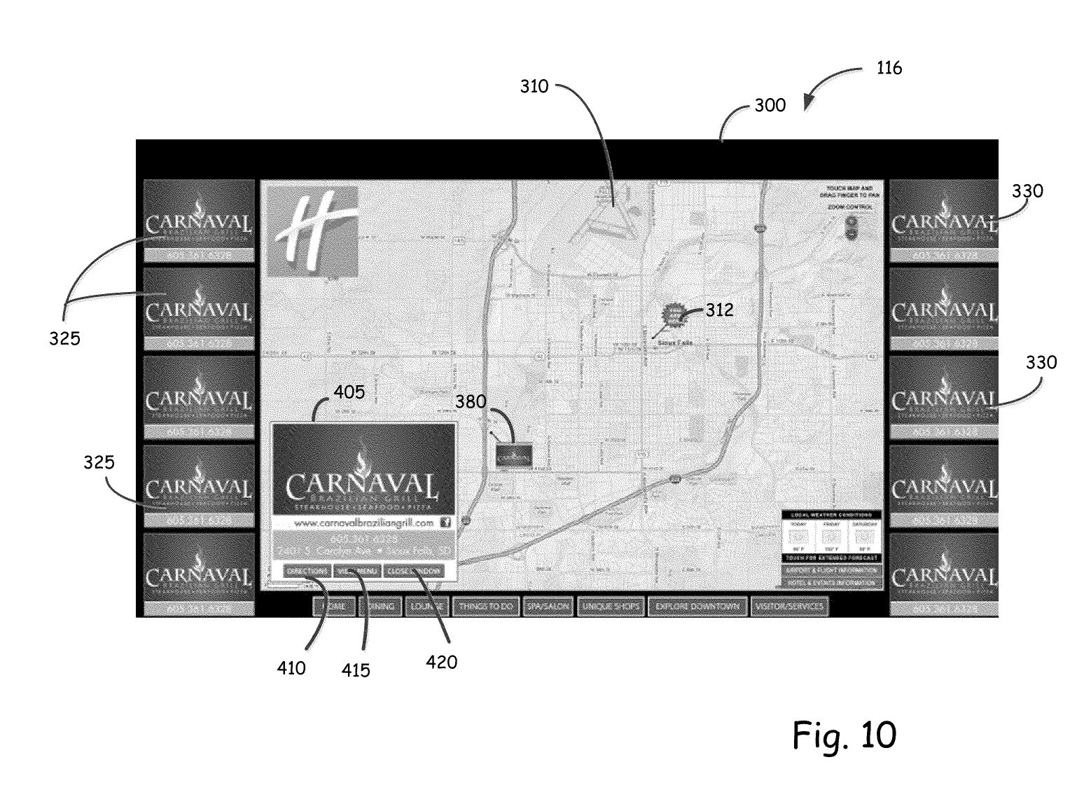

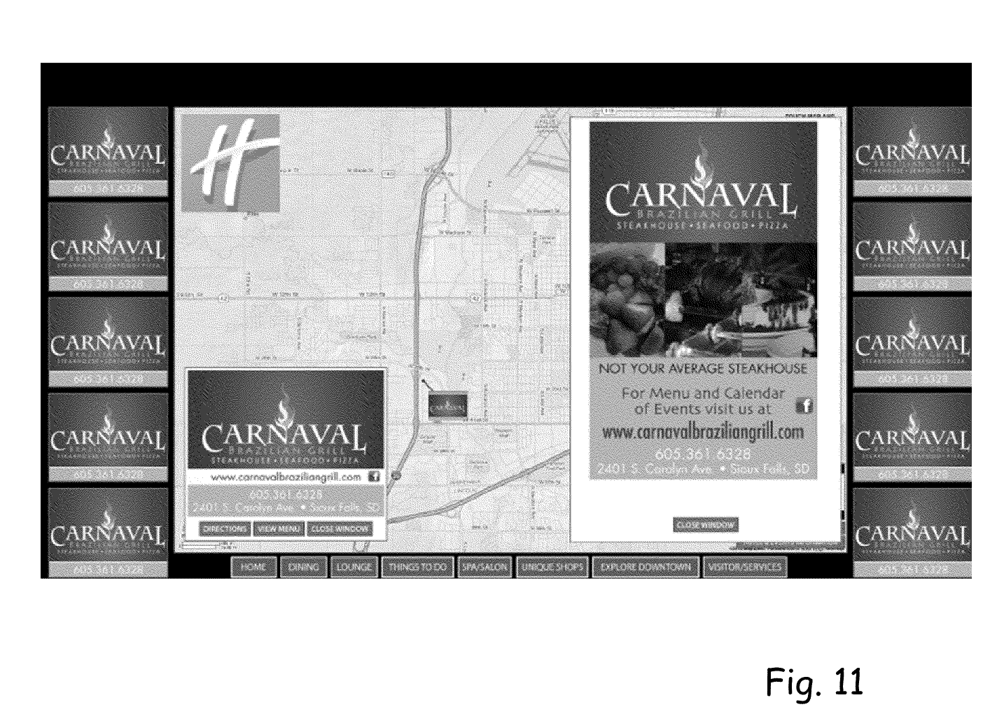

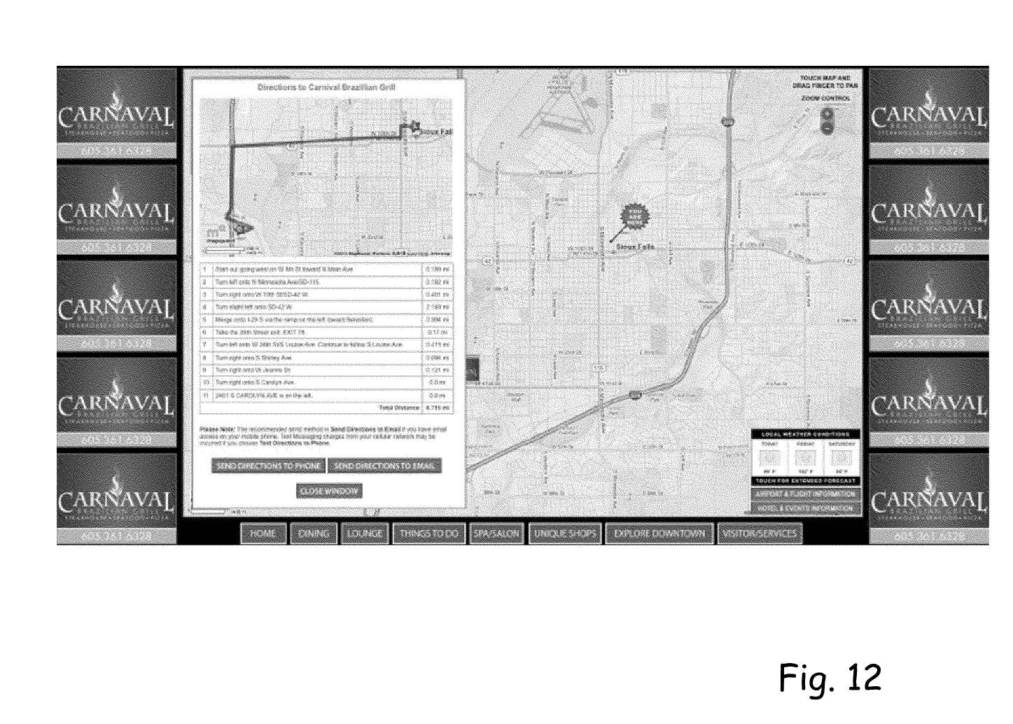

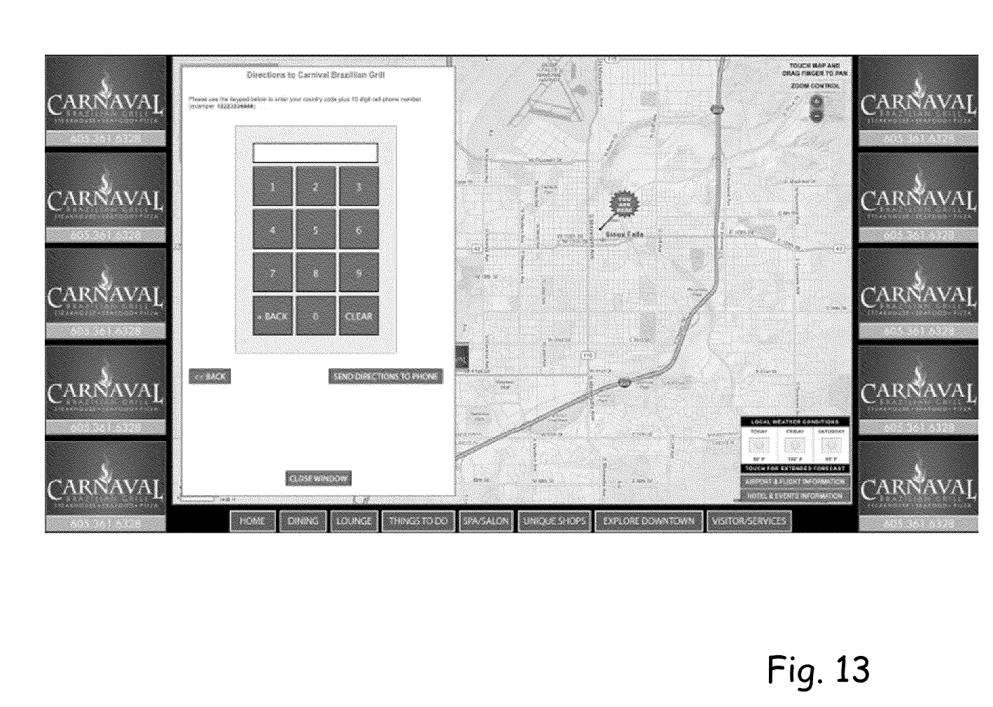

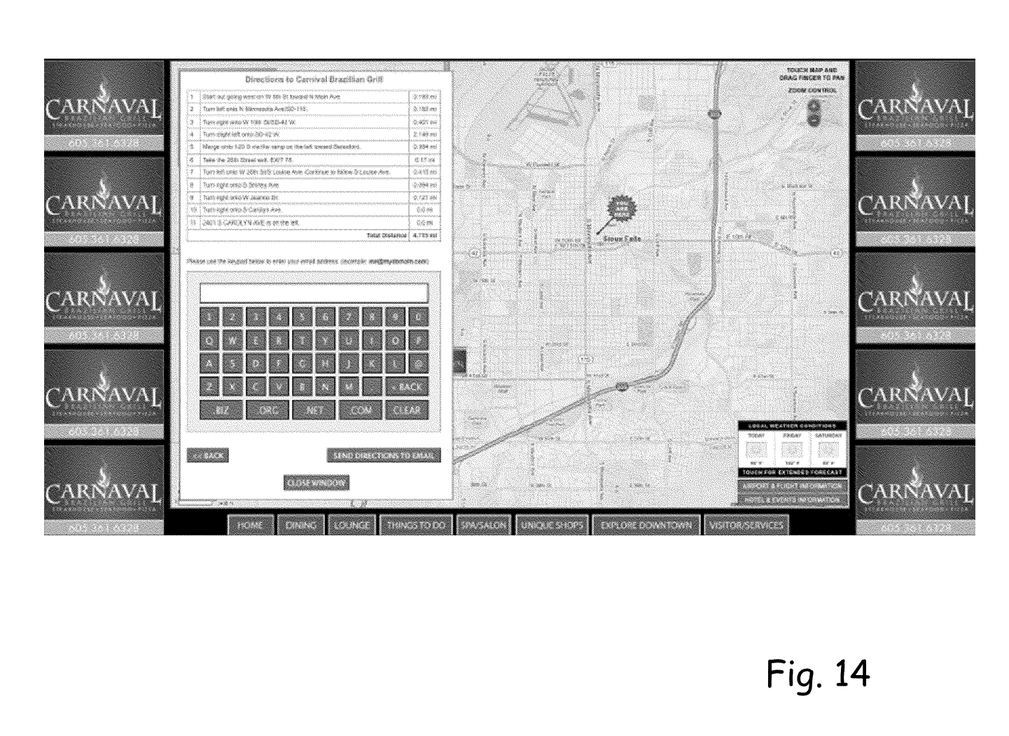

Referring now to FIG. 10, shown is UI 300 in the dining category configuration of FIG. 4, but after one of the side advertisements 325 or 330 has been touched by the guest or user. The result is very similar to that shown in FIG. 5 with a notable difference. Again in this instance, all side advertisements 325 and 330 change to be advertisements for that one selected business. Also, pop-up box 405 again is displayed along with location pinning icon 380. However, one notable difference between UI 300 in the configurations of FIG. 5 and FIG. 10 is that, when a side advertisement has been touched as shown in FIG. 10, row 375 showing advertising icons for various other businesses is no longer displayed. Thus, competing advertisements are eliminated when a user touches a side advertisement, making the larger side advertisements a desired option for businesses wishing to purchase advertising space. FIGS. 11-14 correspond to UI 300 as shown in FIGS. 6-9, but without the display of row 375 showing advertising icons for various other businesses. Thus, FIGS. 11-14 represent UI screens which can be navigated to from the screen shown in FIG. 10.

The above-discussed and illustrated examples follow from a user or guest touching the “DINING” input 344 shown in FIG. 3. However, the display of information is very similar and follows a similar (or the same) flow for other categories of businesses (e.g., UNIQUE SHOPS, THINGS TO DO, etc.). When a category is selected, row 375 is updated with advertising icons for businesses in that category; location pinning icons are added to the map, etc.

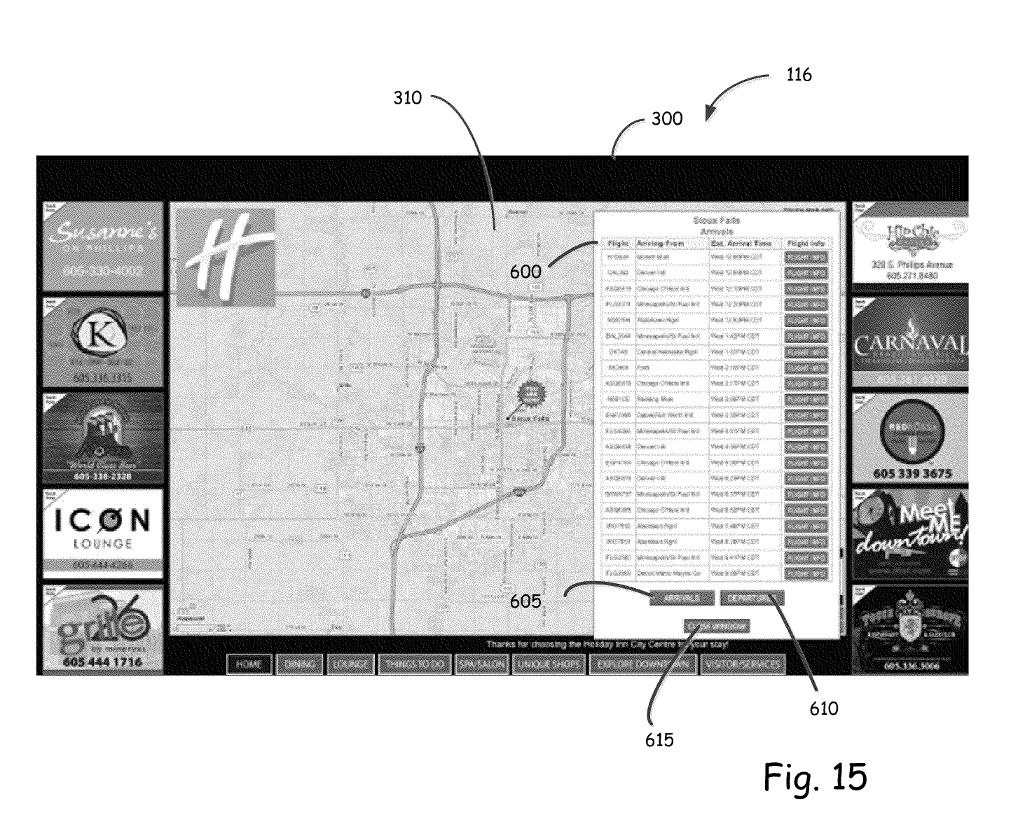

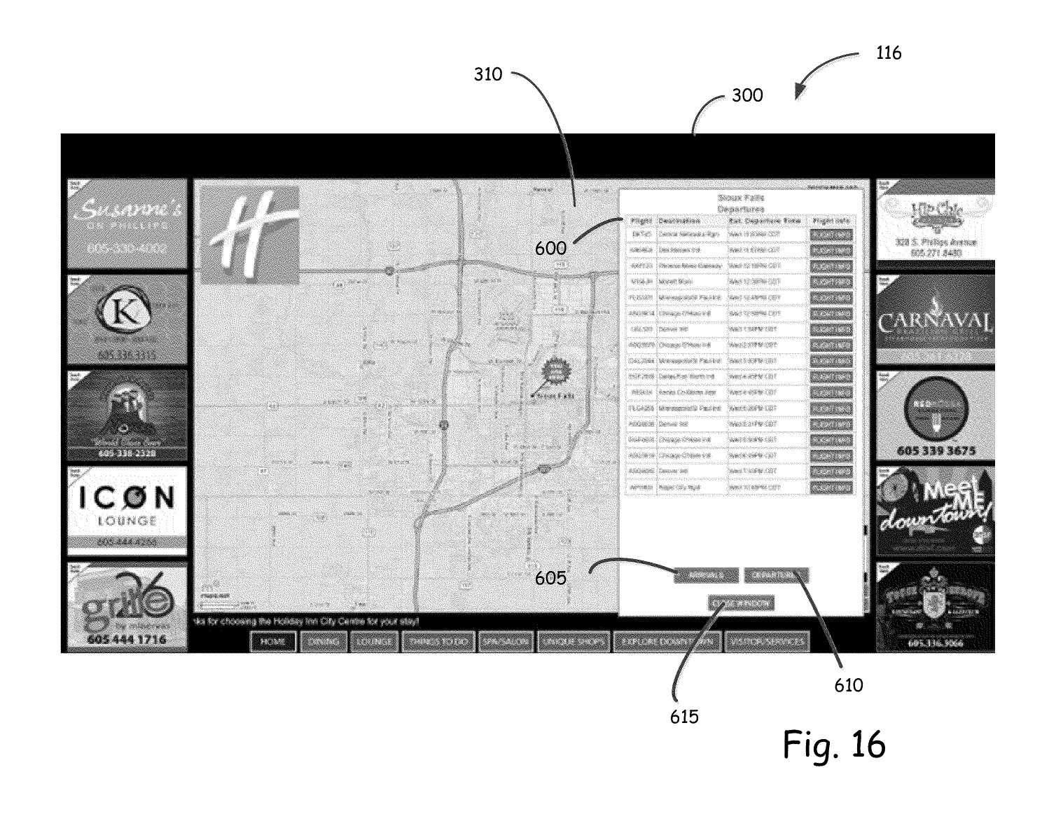

Referring now to FIGS. 15 and 16, shown is display 116 and UI 300 after airport flight information icon or button 322 (shown in FIG. 3) has been touched by a user. A flight information pop-up window 600 is displayed on top of map 310 with arrival (FIG. 15) and/or departure (FIG. 16) information for relevant flights at a nearby airport. The flight information can be obtained from a pay or free service by the owner or operator of system 100 via a network connection 152 such as over the internet. The user can switch between arrival information and departure information by touching “ARRIVALS” input 605 or “DEPARTURES” input 610. Input 615 can be selected to close the flight information window 600.

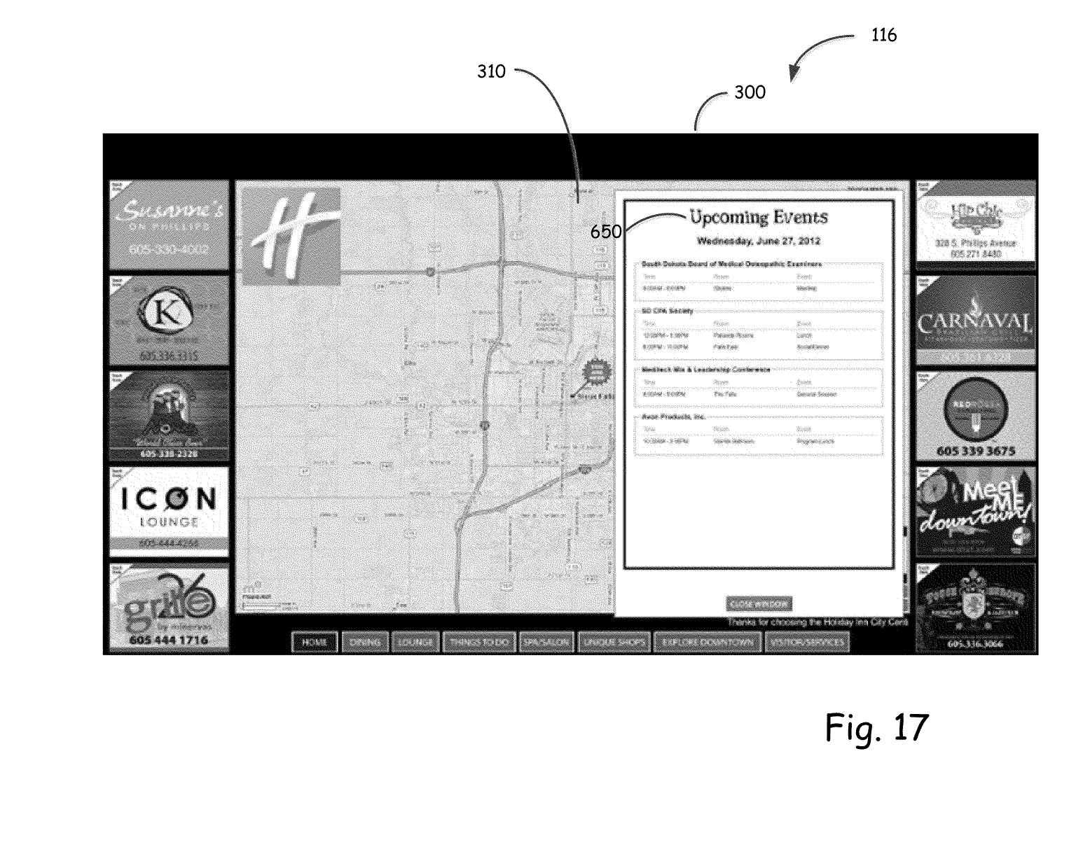

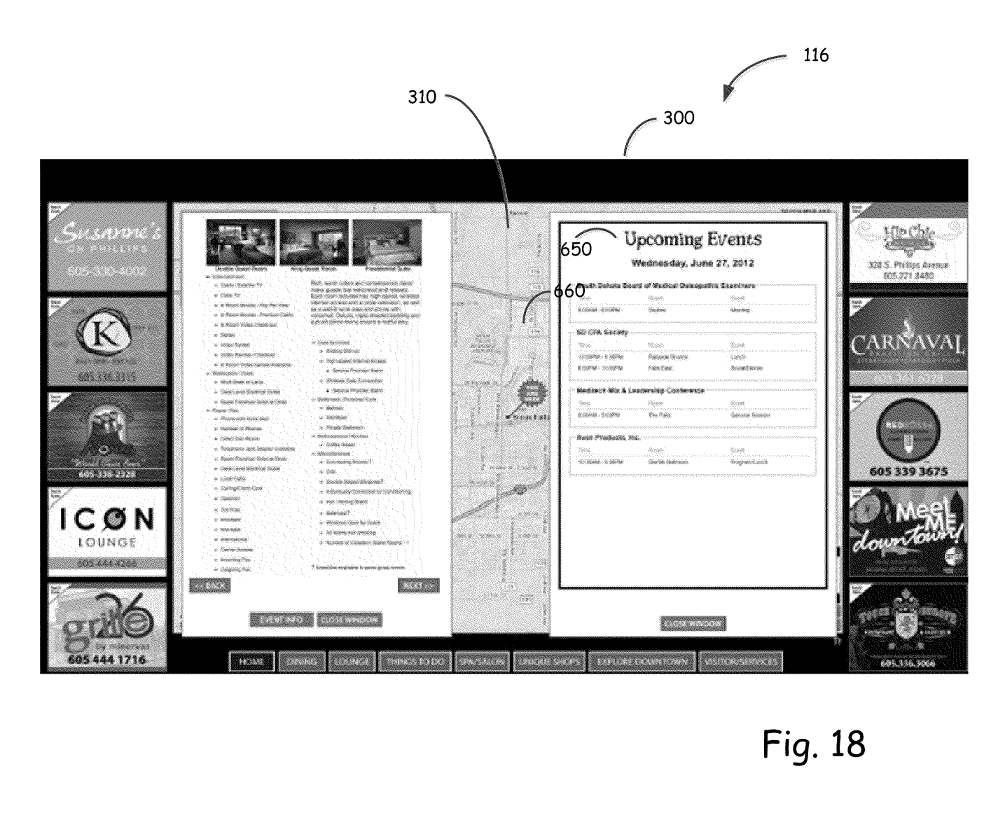

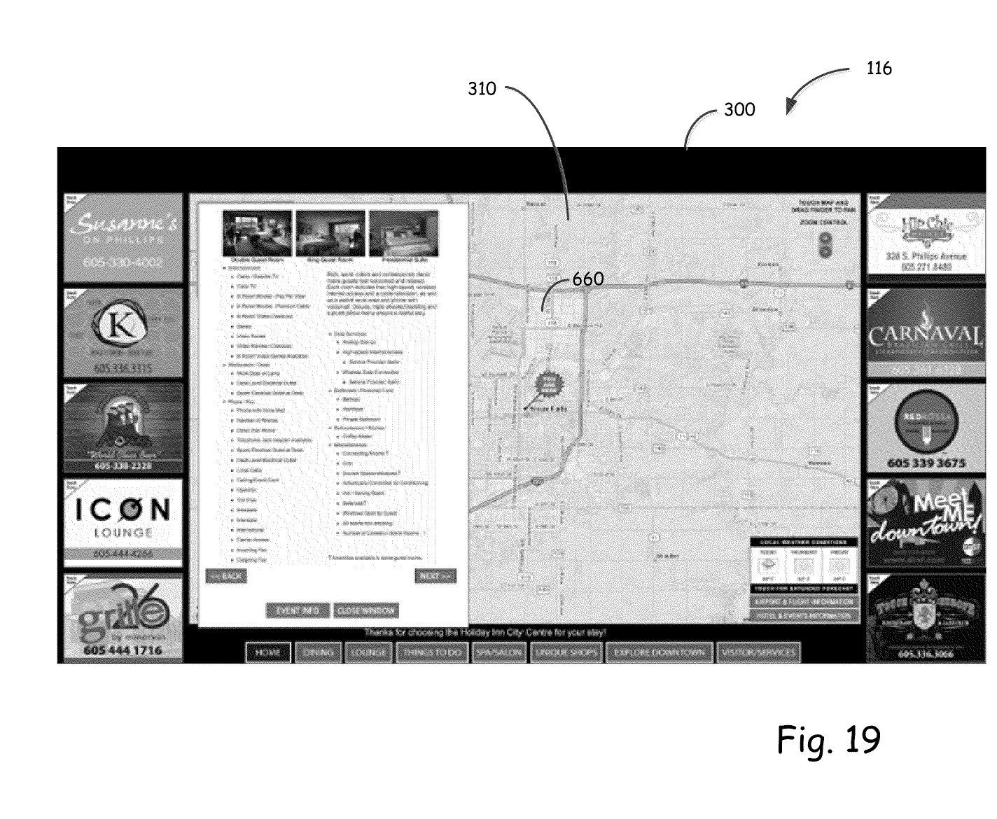

Referring now to FIGS. 17-19, shown is display 116 and UI 300 after hotel and events information icon or button 324 (shown in FIG. 3) has been touched by a user. As shown in FIGS. 17 and 18, an upcoming events pop-up window 650 can be displayed on top of map 310 with information on upcoming events at the hotel or in the surrounding area. As shown in FIG. 18, in some embodiments, touching button 324 causes a hotel information pop-up window 660 to be displayed next to window 650. In the embodiment shown in FIG. 19, window 660 is displayed separately from, or instead of, window 650. Further, separate buttons can be provided to control the display of these two pop-up windows separately in other embodiments.

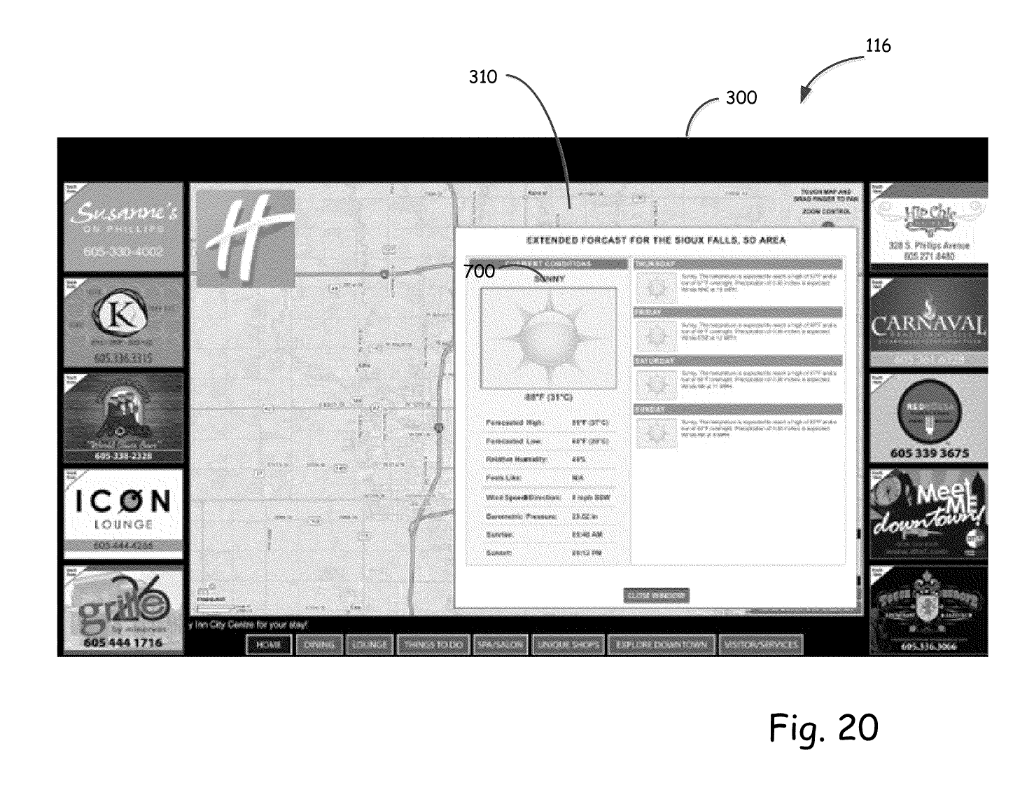

Referring now to FIG. 20, shown is display 116 and UI 300 after airport flight local weather window 320 (shown in FIG. 3) has been touched by a user. An extended forecast information pop-up window 700 is displayed on top of map 310 with extended forecast information. The forecast information can be obtained from a pay or free service by the owner or operator of system 100 via a network connection 152 such as over the internet.

In some embodiments, device or system 100 is configured such that processing unit 102 and the corresponding program modules and program data are used keep track of statistical information relating to the different features accessed by guests or users. For example, statistical information such as a count of the number of times each feature (e.g., weather information, directions, etc.) and/or category (e.g., dining, unique shops, etc.) was accessed by guests over any given period of time, correlation information which correlates the frequency or likelihood of a guest accessing an advertisement after accessing a particular feature, and the like can be calculated and stored for access by an administrator or owner of the system. This information can be used to aid in determining how best to place advertisements or to otherwise analyze use of the touch screen information system.

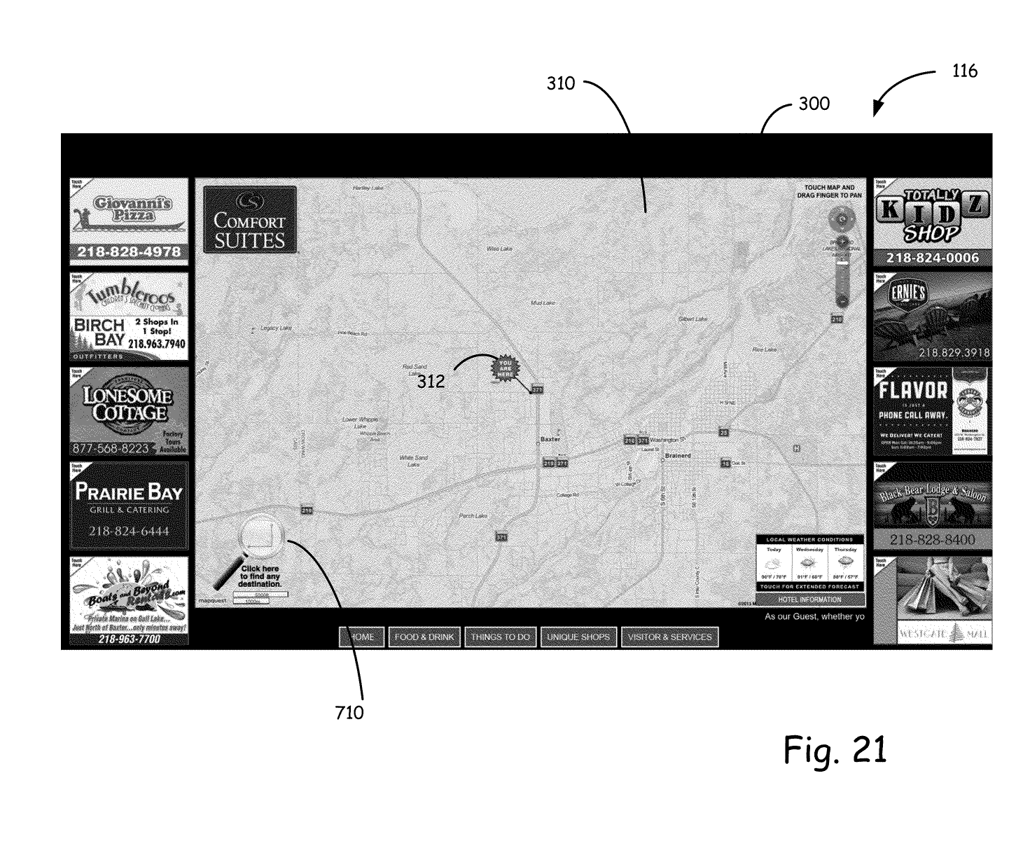

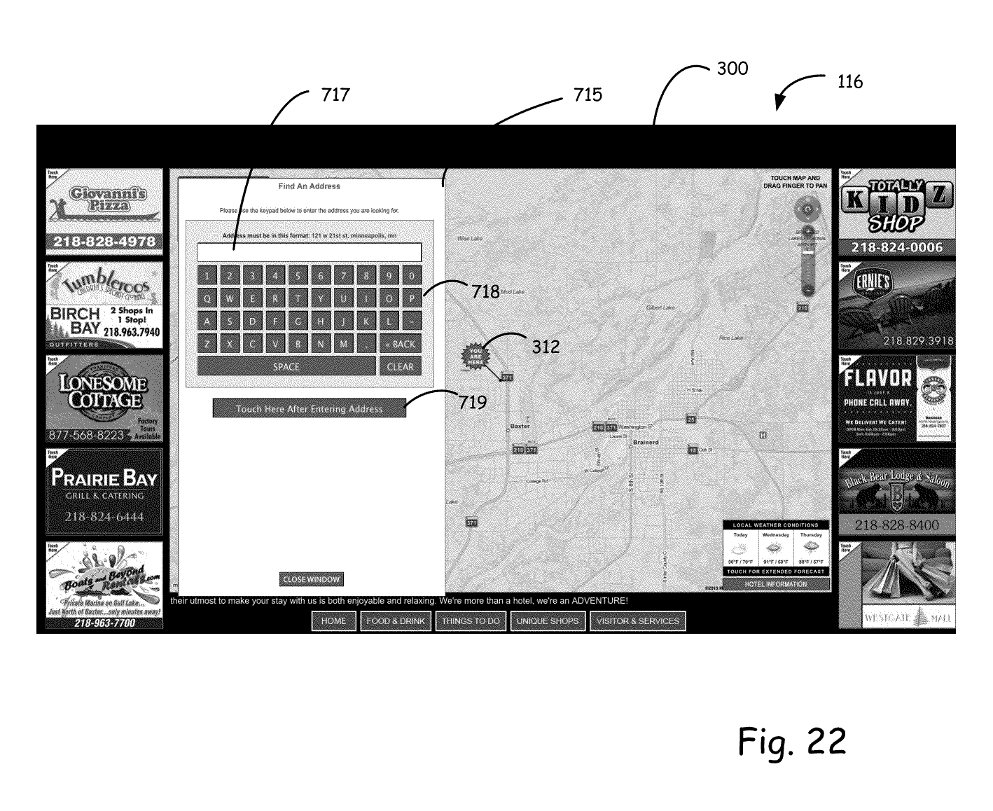

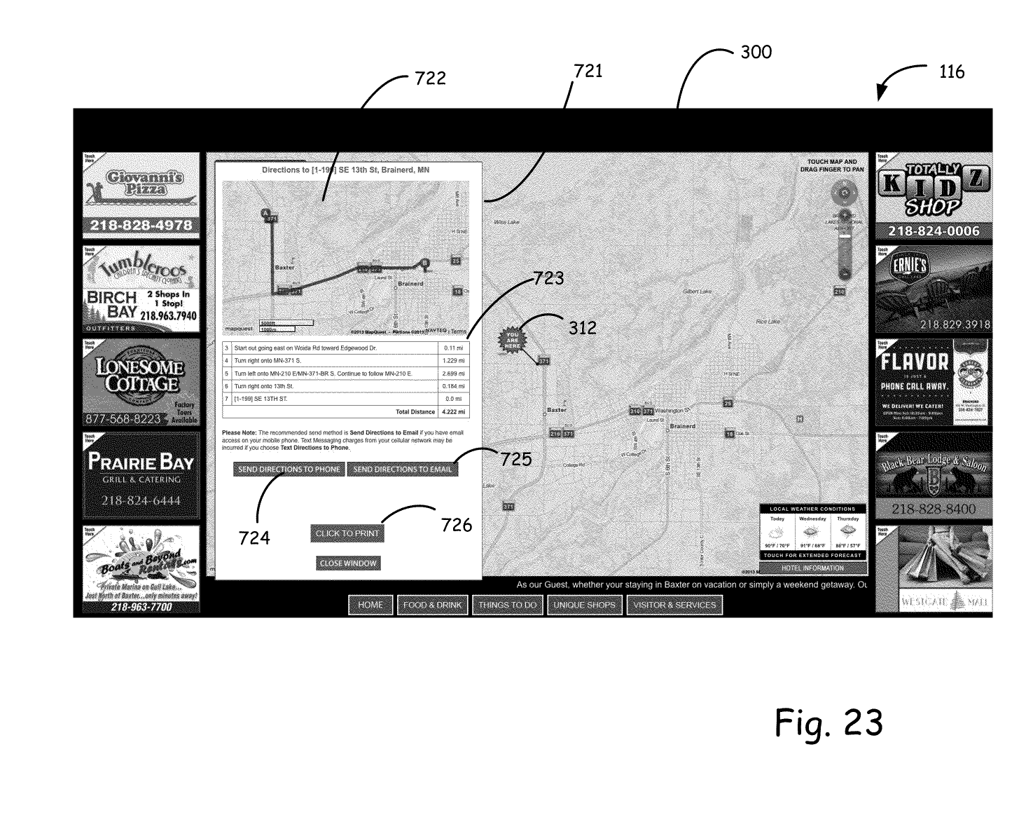

In various exemplary embodiments, a FIND IT feature is included and provided by device or system 100. As shown for example in FIG. 21, some embodiments of UI 300 include a FIND IT icon or input 710 displayed on map 310 which when touched by a user initiates an address based search function implemented by device or system 100. In an example embodiment, the FIND IT input is displayed in the form of a magnifying glass. After touching input 710, a pop-up window 715 is displayed in UI 300 as shown in FIG. 22. The user is then prompted to enter an address of a location they would like to get directions to into input field 717 using displayed touch keyboard 718. After entering an address into input field 717, the user touches input 719 to proceed. As shown in FIG. 23, in response, a pop-up window 721 is displayed in which a second map 722 and step-by-step directions 723 from the current location of the user and device 100 to the desired address are displayed. Similar to embodiments described above, if a user touches input 724, the step-by-step directions will be sent to the user's phone. If a user touches input 725, the step-by-step directions will be sent to the user via email. If a user touches input 726, the map and/or step-by-step directions will be printed at a printer connected to device or system 100 (either through a direct connection or a network connection).

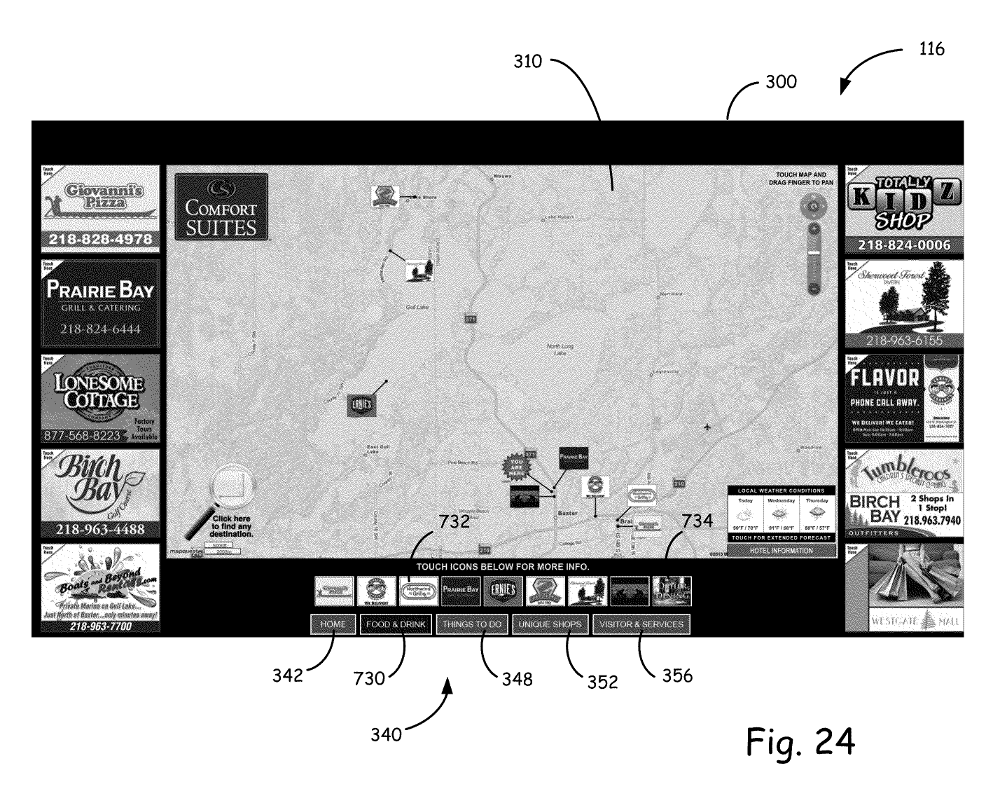

Referring now to FIG. 24, shown is an embodiment of UI 300 in which the home screen UI including bar or row 340 of user selectable buttons or inputs, which can be touched by a user to cause device 100 to open different pop-up windows to obtain additional information, are categorized slightly differently than as shown in FIG. 3. In this embodiment, bar or row 340 includes a FOOD & DRINK input 730, instead of DINING input 344 as was the case with previously described embodiments. On map 310, a number of restaurant icons are then displayed and associated with a pinned location of the restaurant by a generated line such that a user can move the restaurant icon by touching the screen and dragging the icon, while the visual association with the pinned location of the restaurant is maintained. This features functions as described above with reference to previous Figs.

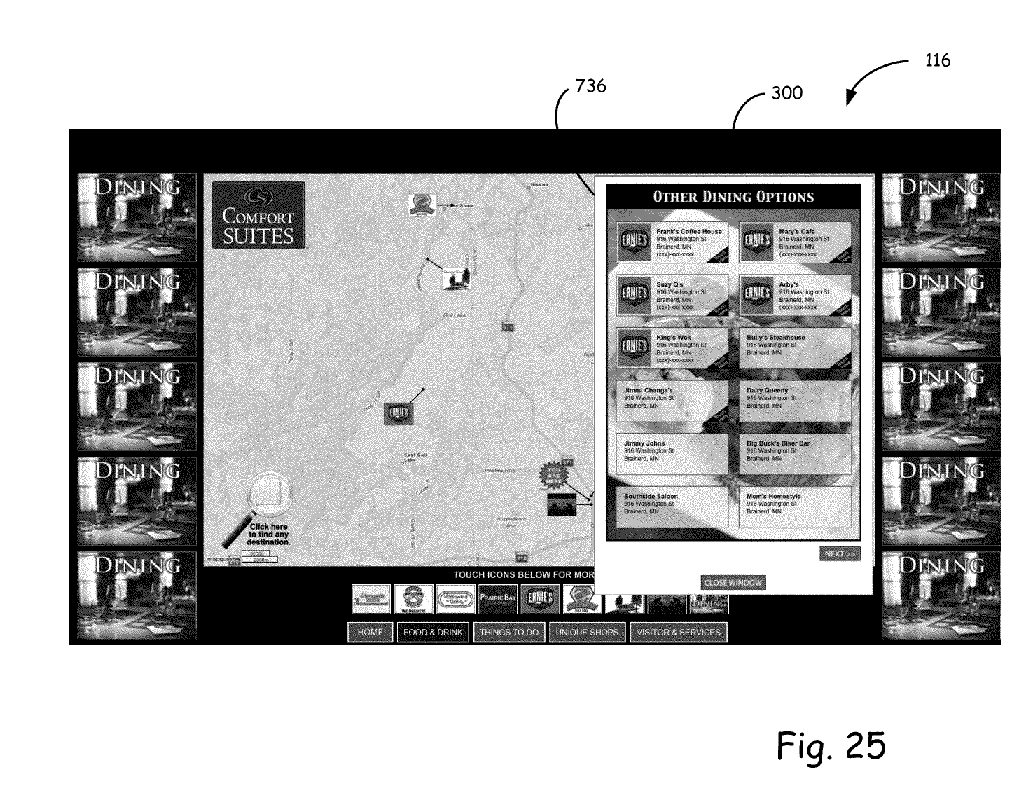

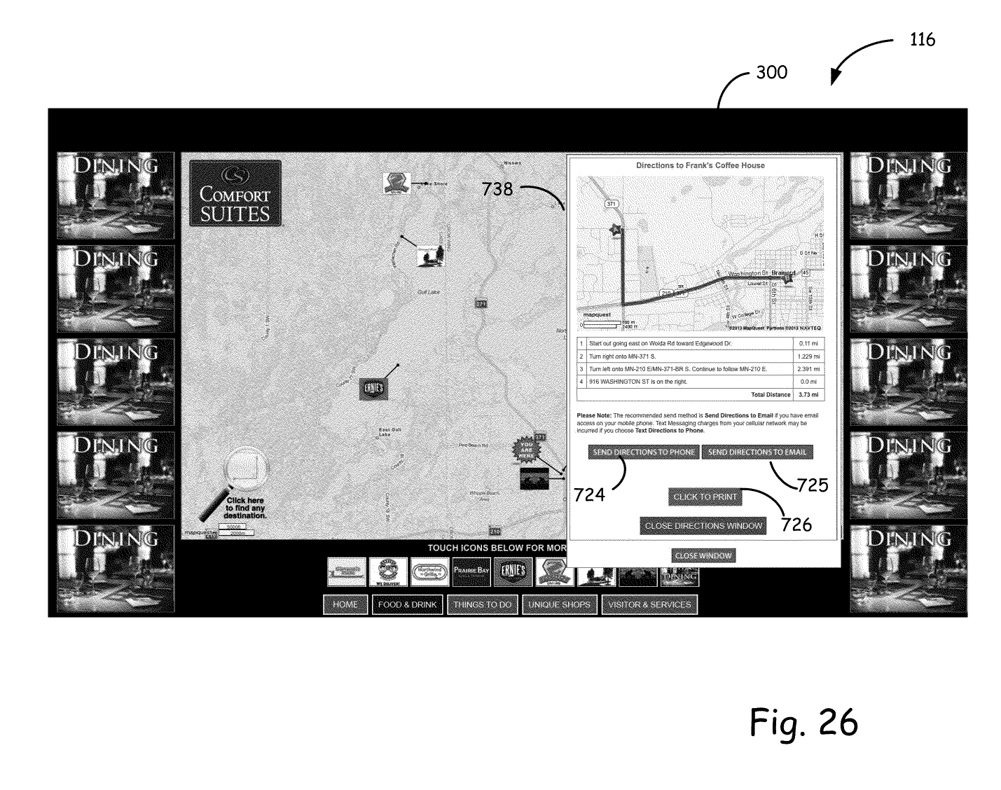

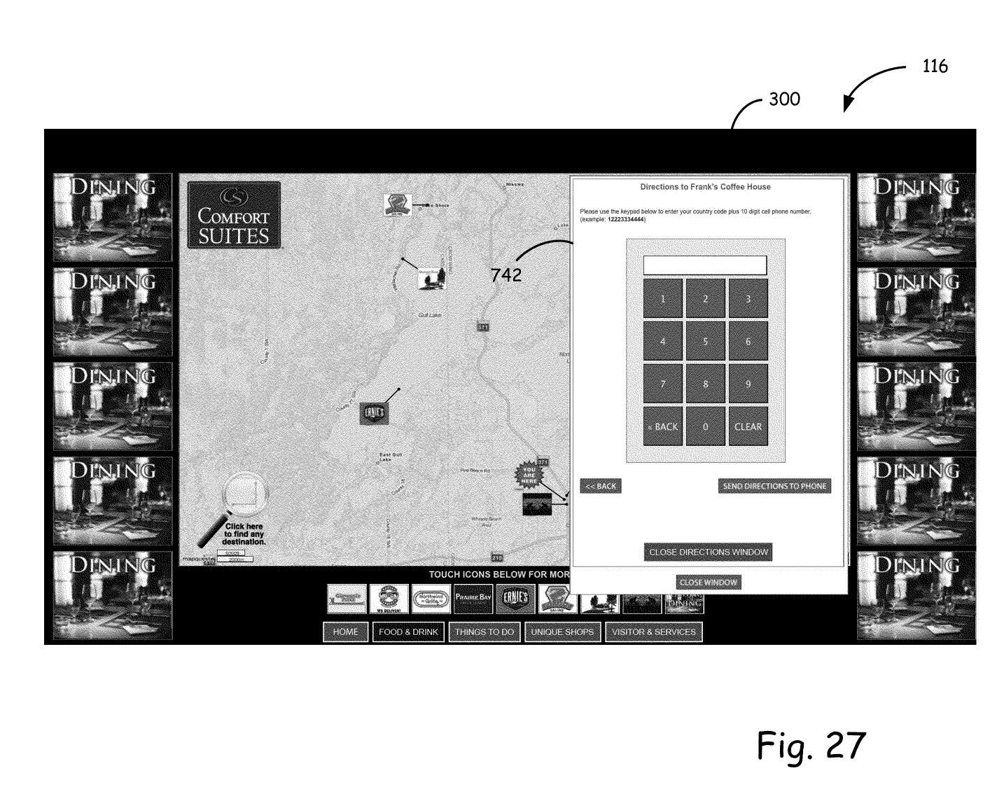

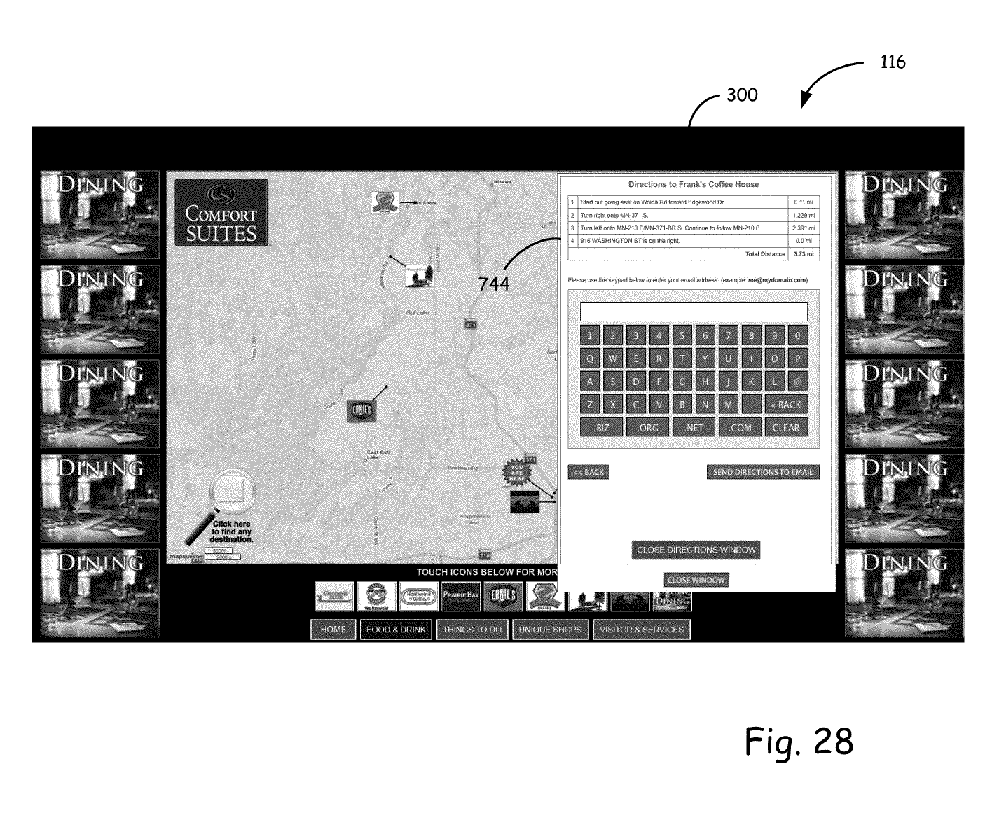

Also included within the row of FOOD & DRINK icons, is an “OTHER DINING” icon 734. When a user touches the “OTHER DINING” input 734, a pop-up window 736 is displayed in UI 300 as shown in FIG. 25. If a user touches one of the inputs in window 736 corresponding to a particular dining establishment, a pop-up window 738 containing a map and step-by-step driving instructions to the dining establishment is displayed as shown in FIG. 26. Pop-up window 738 includes inputs 724, 725 and 726 as discussed above with reference to pop-up window 721 shown in FIG. 23, which allow the directions to be sent to the user's phone, sent to a user's email, or printed. If a user touches input 724, a pop-up window 742 (shown in FIG. 27) is displayed in UI 300 which allows the user to input a telephone number for the directions to be sent to. Device or system 100 is configured such that pop-up window 742 includes the same or similar features as pop-up window 500 shown in FIG. 8 and discussed above. Therefore, the reference numbers detailing the different features of pop-up window 742 are not discussed separately here. If a user touches input 725, a pop-up window 744 (shown in FIG. 28) is displayed in UI 300 which allows the user to input an email address for the directions to be sent to. Device or system 100 is configured such that pop-up window 744 includes the same or similar features as pop-up window 520 shown in FIG. 9 and discussed above. Therefore, the reference numbers detailing the different features of pop-up window 744 are not discussed separately here.

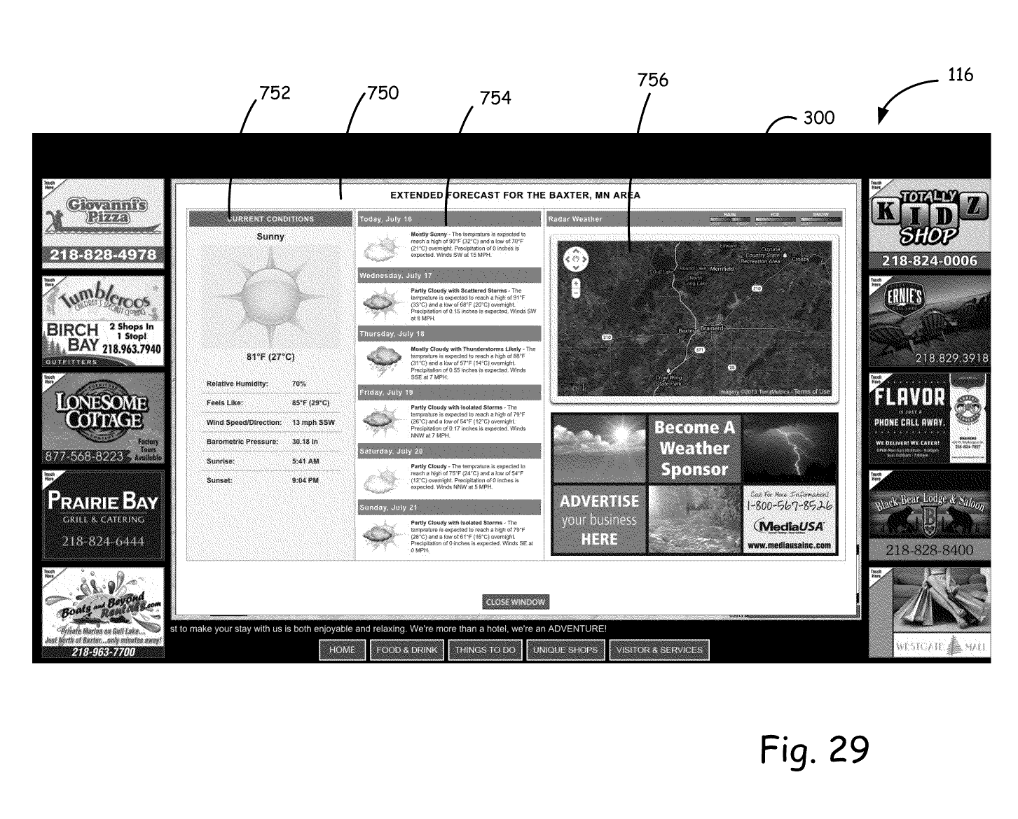

Referring now to FIG. 29, shown is a feature of some embodiments of device or system 100 in which UI 300 provides a weather window 750 containing more detailed weather information than discussed above with reference to FIG. 3. If a user clicks on weather window 320 shown in FIG. 3, weather window 750 is caused to be displayed on device 116 as part of UI 300. With a subscription to a weather service provider, window 750 includes more detailed information including current conditions pane 752, extended daily forecast pane 754 and weather radar 756. Thus, a user of device or system 100 in a hotel lobby or other business location can obtain detailed weather related information for their stay.

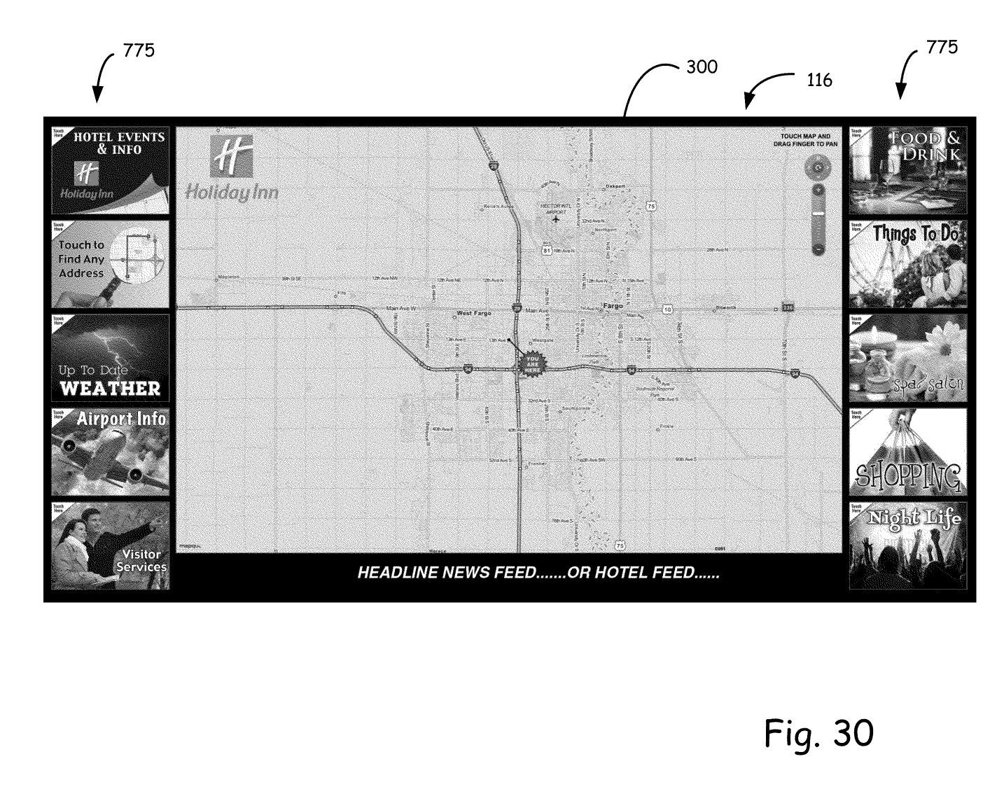

Referring now to FIG. 30, shown is an embodiment of UI 300 provided by the device or system 100 which is not based on, and does not include, advertisements from paid advertisers. Some hotels, convention centers or other businesses in which system or device 100 may be installed prefer not to have advertisements for other businesses, or prefer more control over displayed information. FIGS. 30-47 illustrate embodiments in which such paid advertisements are removed and the UI 300 is rearranged accordingly. Although FIGS. 30-47 are described as being non-advertisement based, in other embodiments the display configuration of these Figs. can be used in conjunction with paid advertisements. As shown in FIG. 30, the bar or row 340 (shown in FIG. 3) of user selectable buttons or inputs which can be touched to cause device 100 to open different pop-up windows or different desired categories is removed. Instead, user inputs 775 are included on the sides of UI 300 for accessing various categories of information and causing pop-up windows for those categories to be displayed.

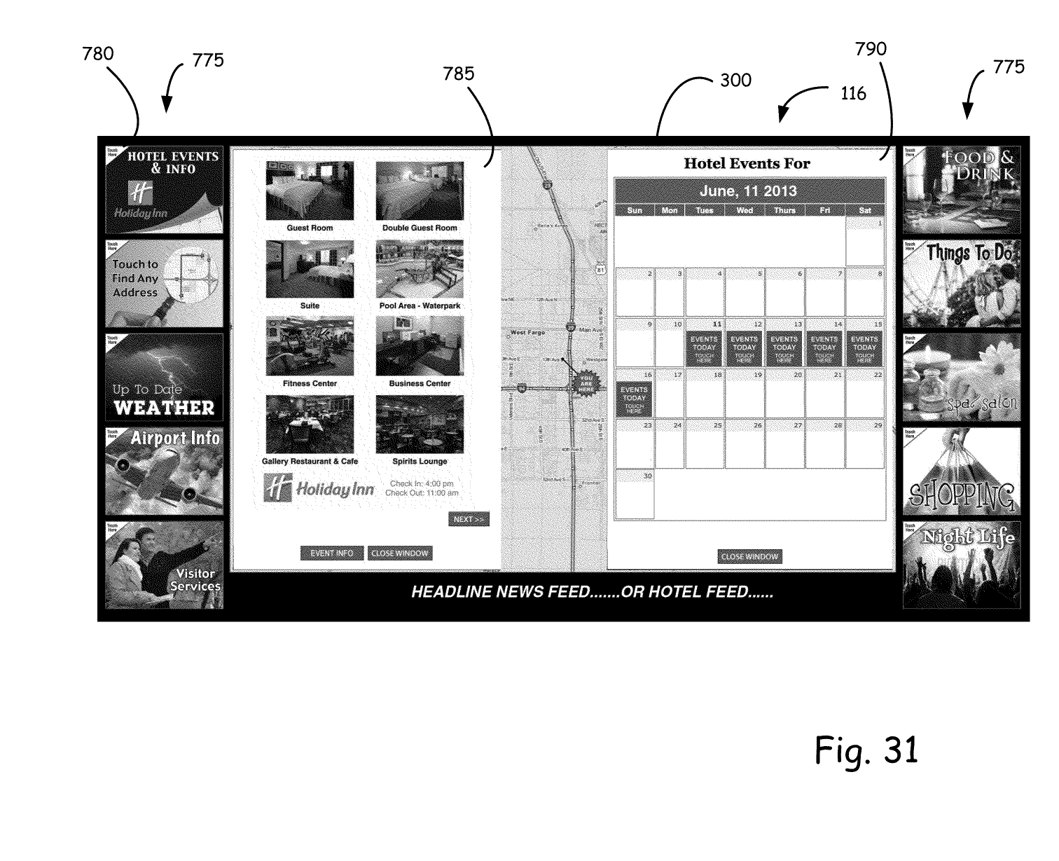

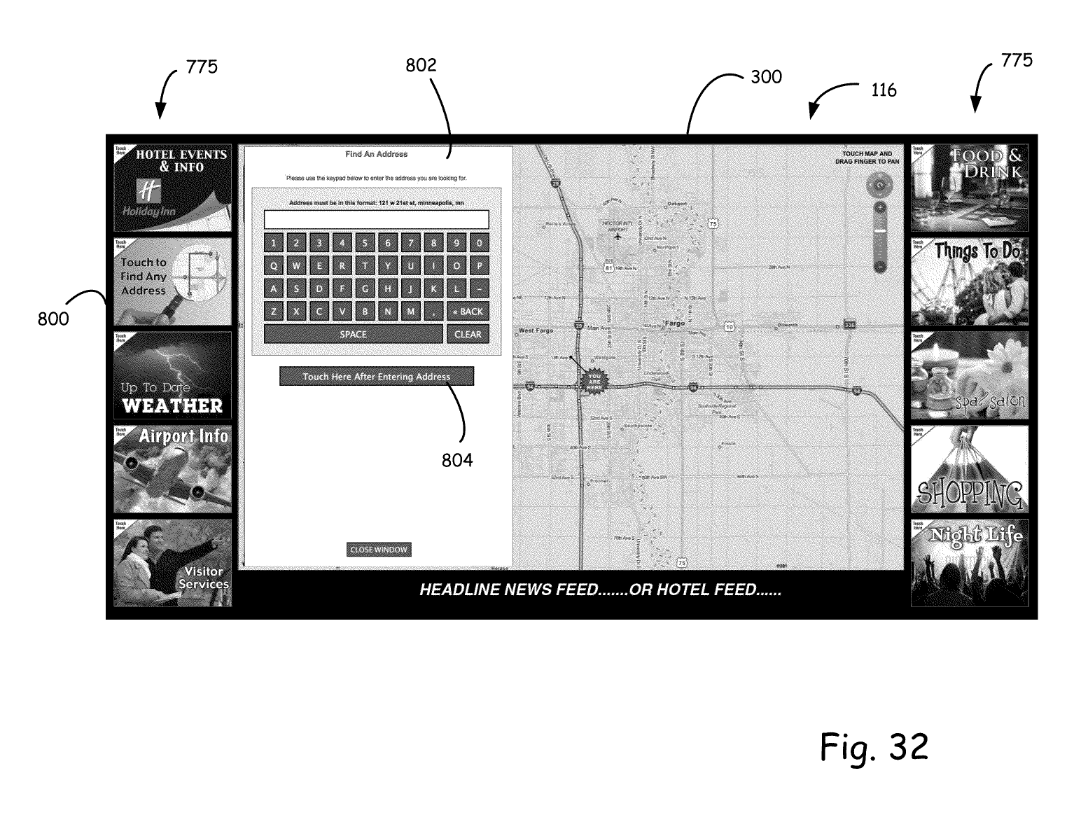

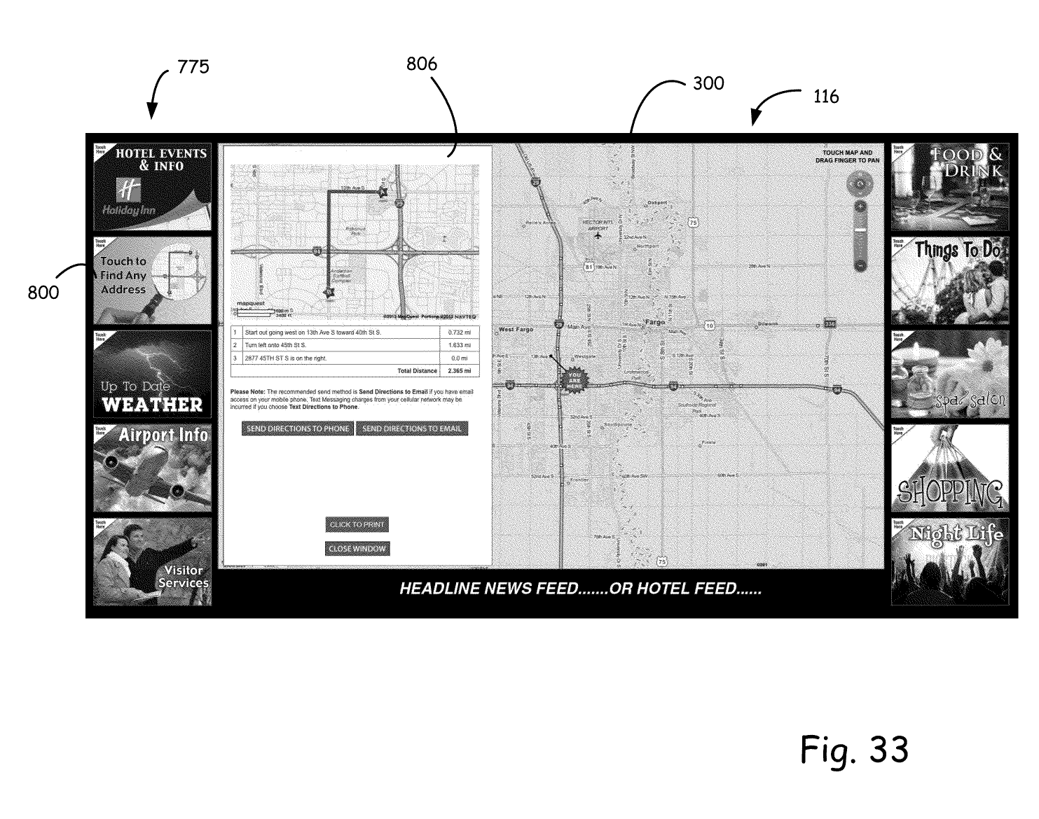

Referring to FIG. 31, when a user touches the HOTEL EVENTS & INFO input 780 on the left hand side of user inputs 775, hotel events and information type content is displayed on UI 300. For example, in one example embodiment, touching input 780 causes a first pop-up window 785 with hotel accommodations information to be displayed, and a second pop-up window 790 with a calendar of hotel events to also be displayed. Referring now to FIG. 32, if FIND IT input 800 is touched, a pop-up window 802 is displayed allowing the user to input an address for which directions and a map are desired. Upon the user entering an address and touching the input 804, a map and step-by-step are displayed as shown in FIG. 33. FIND IT feature 800, pop-up window 802 and pop-up window 806 are the same as, or substantially similar to, these features of advertisement-based UI 300 discussed above with reference to FIGS. 21-23.

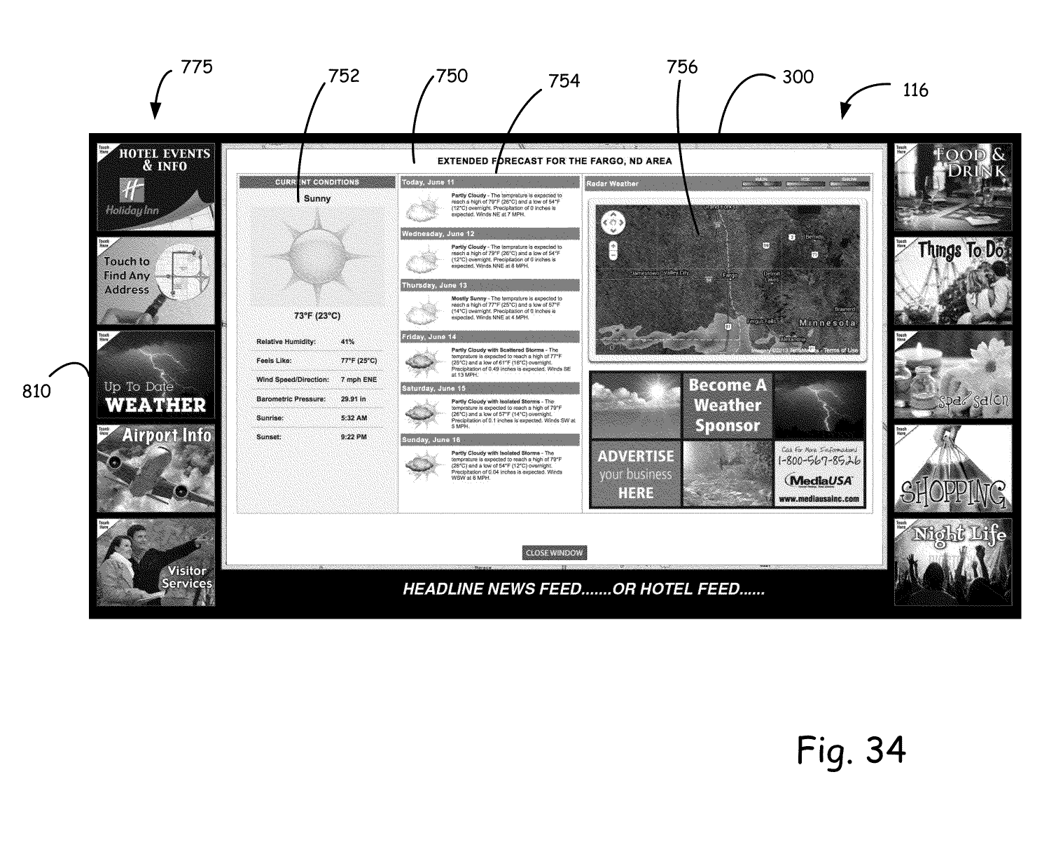

Referring now to FIG. 34, shown is UI 300 when WEATHER input 810 is touched. When a user touches WEATHER input 810, weather window 750 described above with reference to FIG. 29 is displayed, providing current conditions information, extended forecast information, and weather radar information.

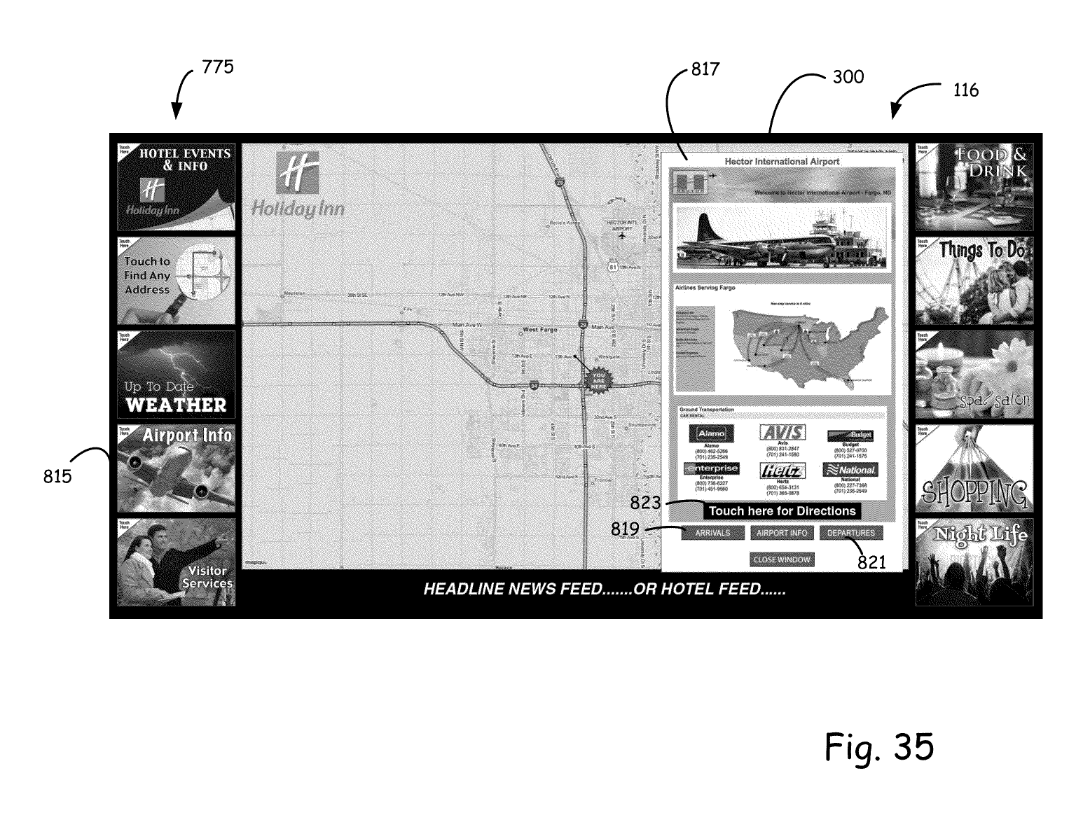

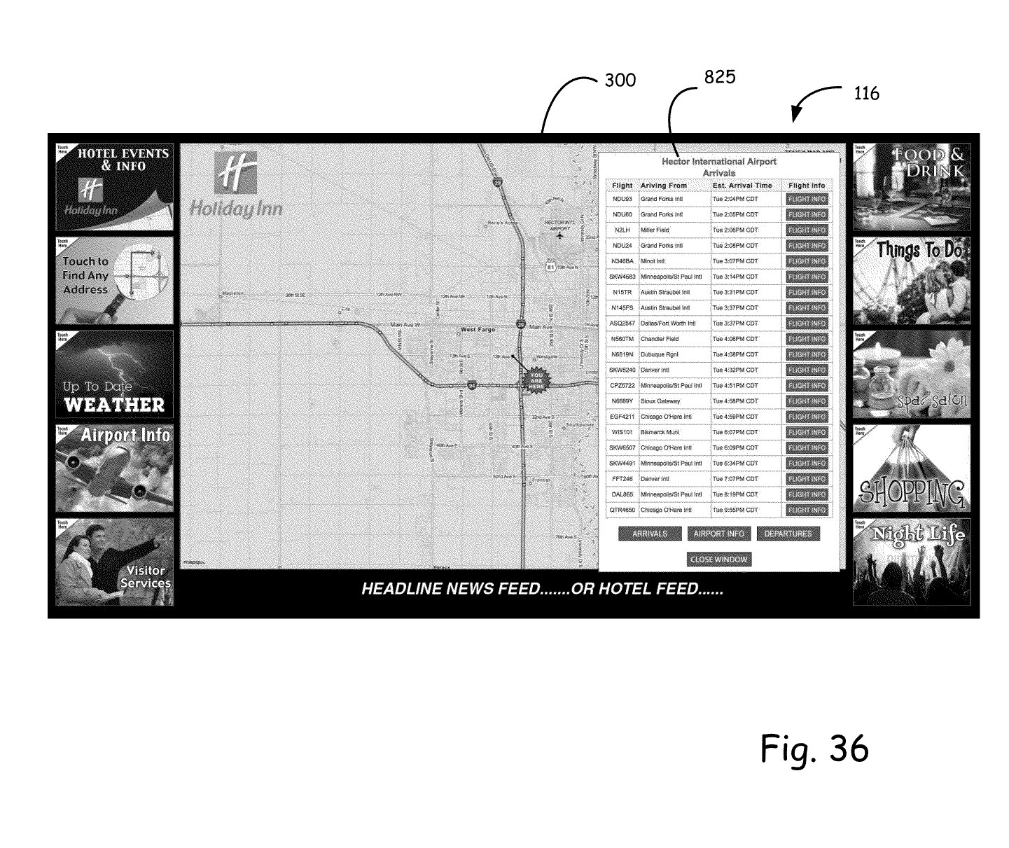

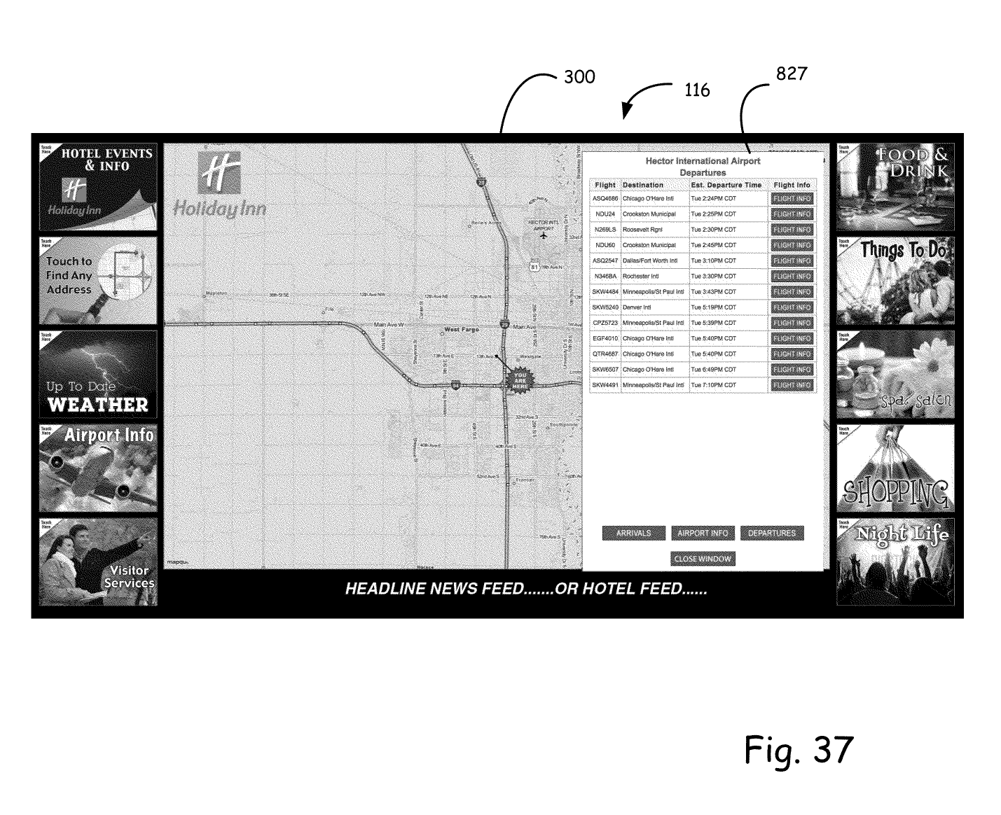

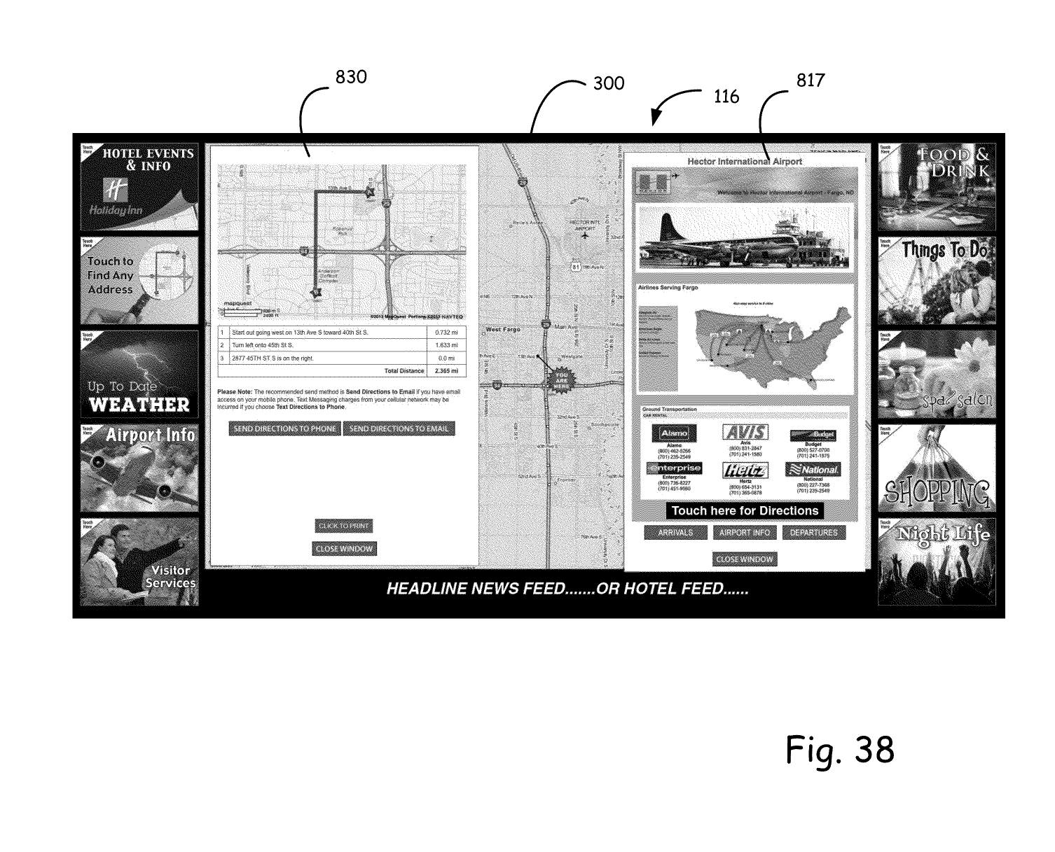

Referring now to FIG. 35, when AIRPORT INFO user input 815 is touched by a user, pop-up window 817 is displayed providing airport information. The airport information can include route information for airlines serving the particular airport, rental car information, or other information. Pop-up window 817 including airport information has an ARRIVALS input 819 and a DEPARTURES input 821. As discussed above with reference to advertisement-based formatting, when a user touches the ARRIVALS input 819, a pop-up window 825 is displayed as shown in FIG. 36. When DEPARTURES input 821 is touched, a pop-up window 827 showing airport departure information is displayed as shown in FIG. 37. Also included in AIRPORT INFORMATION pop-up window 817 is a DIRECTIONS input 823. When DIRECTIONS input 823 is touched, a DIRECTIONS pop-up window 830, similar or the same as that described above with reference to advertising-based embodiments, is displayed showing both a map and step-by-step directions to the airport. This is shown in FIG. 38.

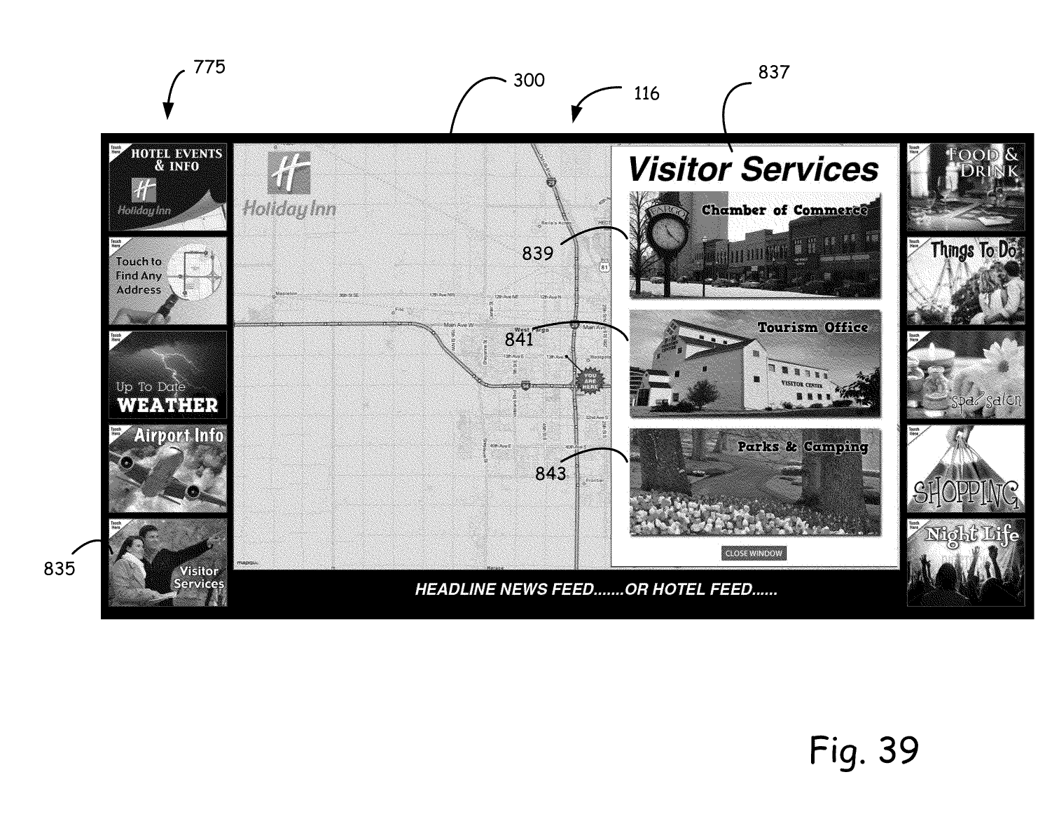

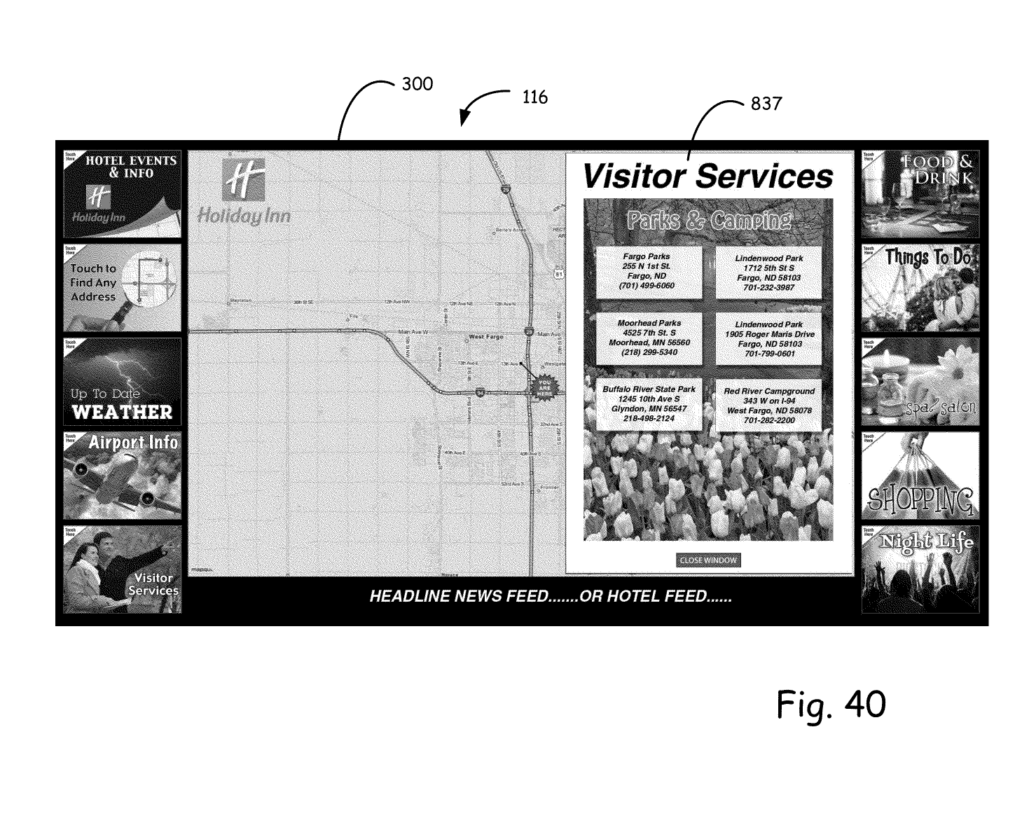

As shown in FIG. 39, when a user touches VISITOR SERVICES input 835 on the side of UI 300, a VISITOR SERVICES pop-up window 837 is displayed. In one exemplary embodiment, VISITOR SERVICES pop-up window 837 includes a CHAMBER OF COMMERCE input 839, a TOURISM OFFICE input 841, and a PARKS AND CAMPING input 843. Other or alternate types of inputs and information can be included on VISITOR SERVICES pop-up window 837 as well. In one exemplary embodiment, when a user touches PARKS AND CAMPING input 843 in pop-up window 837 shown in FIG. 39, the VISITOR SERVICES pop-up window 837 displays detailed information regarding various local parks or campgrounds as shown in FIG. 40. For instance, in the example shown, VISITOR SERVICES pop-up window 837 displays names and addresses of various nearby parks and campgrounds.

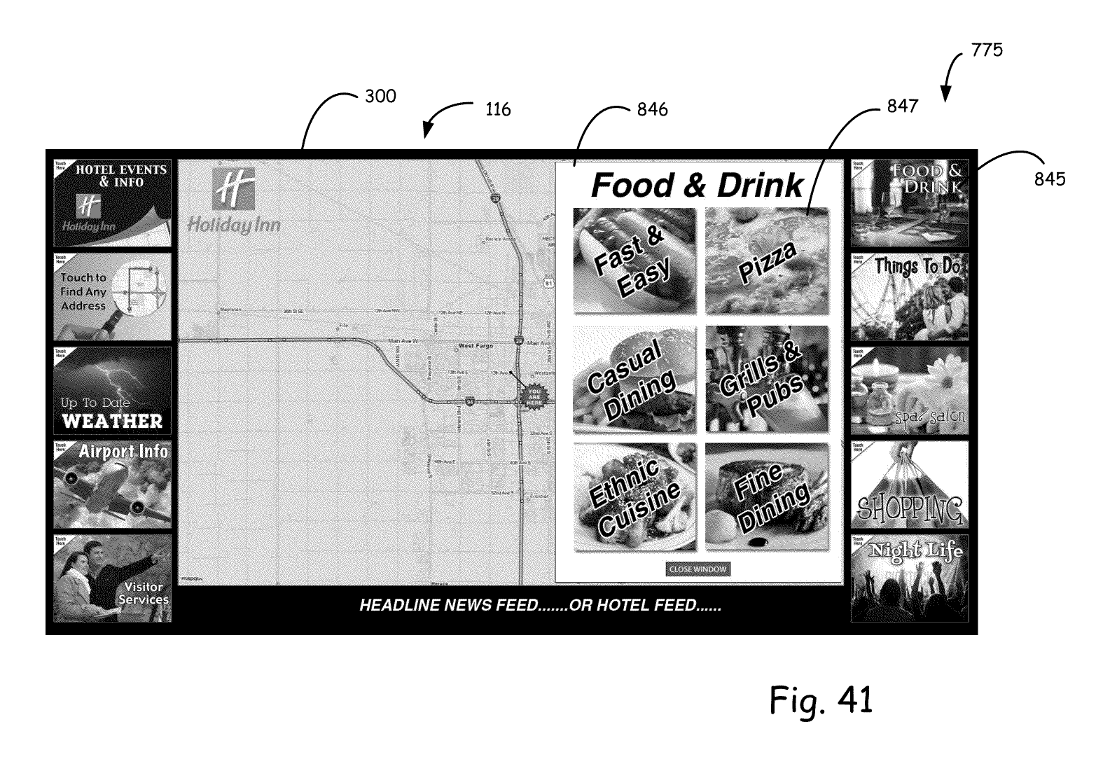

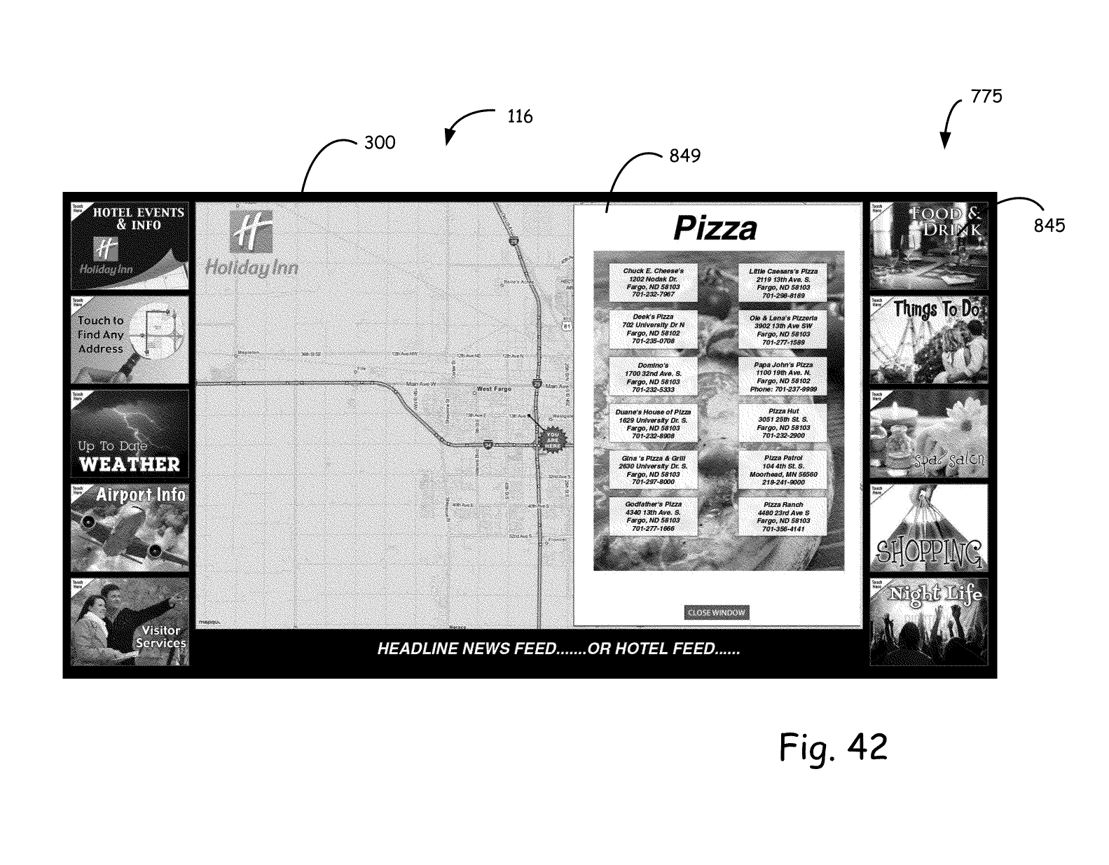

Referring now to FIG. 41, shown as one of user inputs 775 is a FOOD & DRINK user input 845. When a user touches FOOD & DRINK user input 845, a FOOD & DRINK pop-up window 846 is displayed on UI 300. FOOD & DRINK pop-up window 846 includes various inputs correlated to different types of food and dining experiences. For example, when a user touches PIZZA category input 847, a PIZZA category pop-up window 849 is displayed on UI 300 as shown in FIG. 42. Pop-up window 849 for the PIZZA category of FOOD & DRINK displays names and addresses of nearby pizza restaurants.

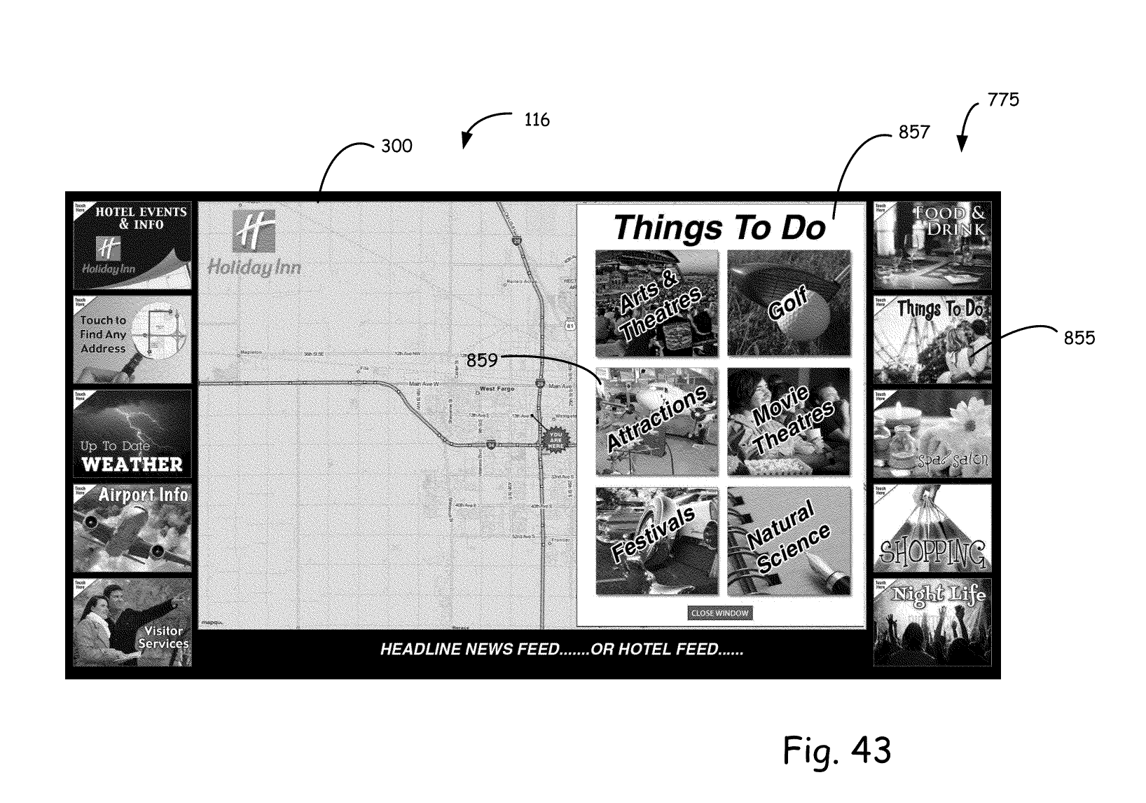

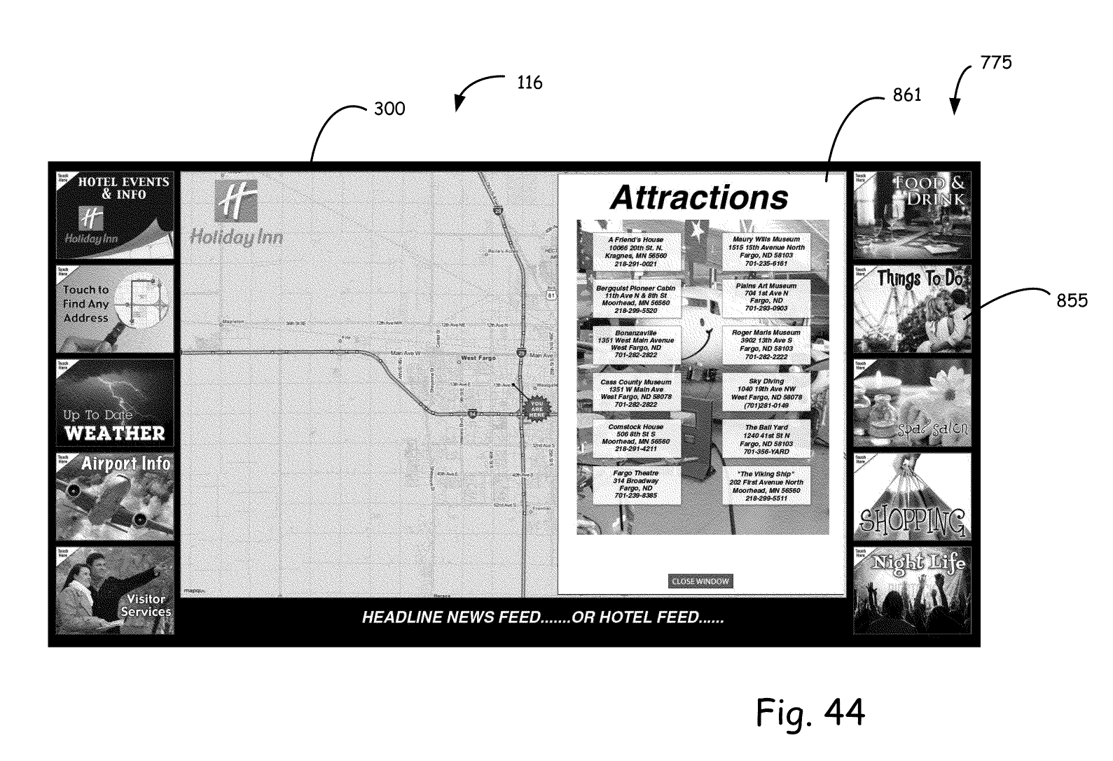

Referring now to FIG. 43, shown as included in user inputs 775 on a side of UI 300 is THINGS TO DO user input 855. When a user touches THINGS TO DO input 855, a THINGS TO DO pop-up window 857 is displayed. Pop-up window 857 includes various user inputs for accessing information related to different categories of THINGS TO DO. For example, if a user touches ATTRACTIONS input 859, an ATTRACTIONS pop-up window 861 is displayed, as shown in FIG. 44, providing names and addresses of various different local attractions.

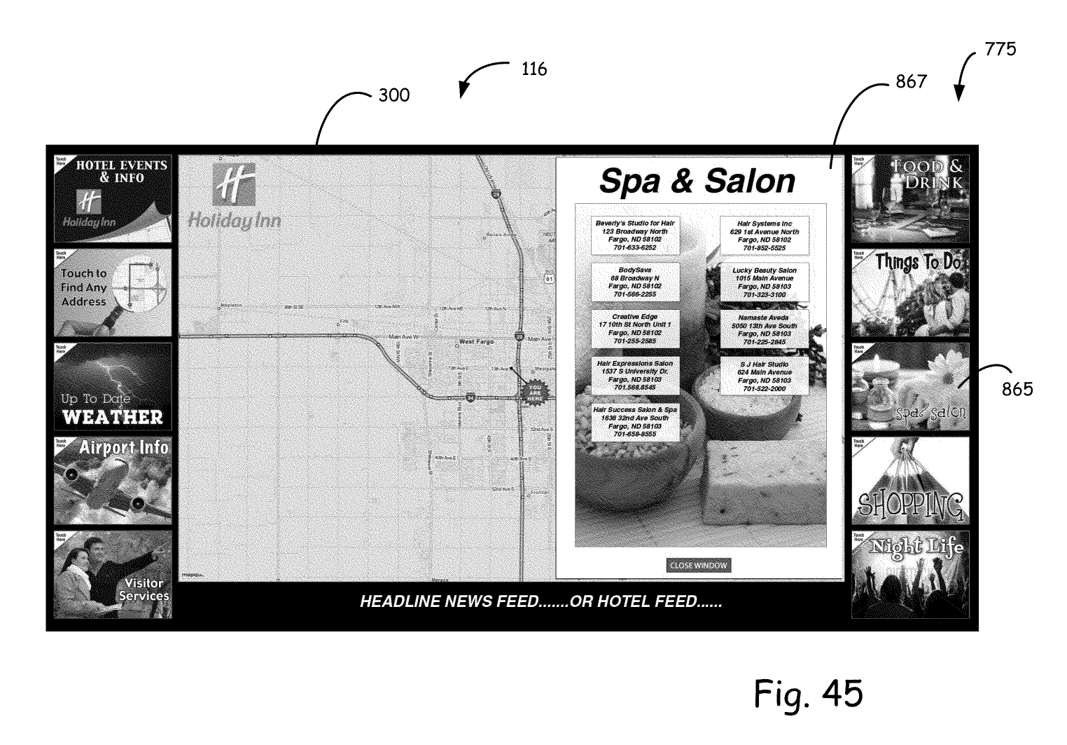

Referring now to FIG. 45, shown as one of user inputs 775 is a SPA AND SALON user input 865. When a user touches SPA AND SALON user input 865, a SPA AND SALON pop-up window 867 is displayed. SPA AND SALON pop-up window 867 lists names and addresses of various local spas and salons.

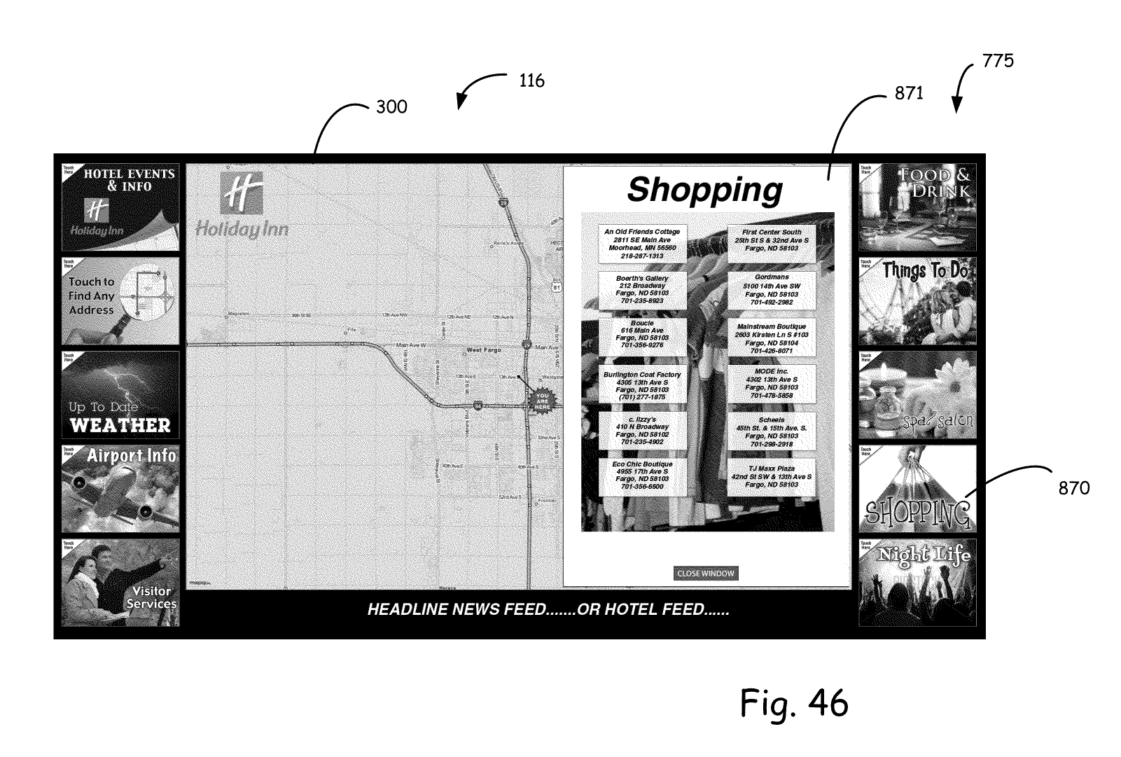

Referring now to FIG. 46, shown as one of user inputs 775 is SHOPPING user input 870. When a user touches SHOPPING user input 870, a SHOPPING pop-up window 871 is displayed. SHOPPING pop-up window 871 lists names and addresses of various local stores and/or shopping centers.

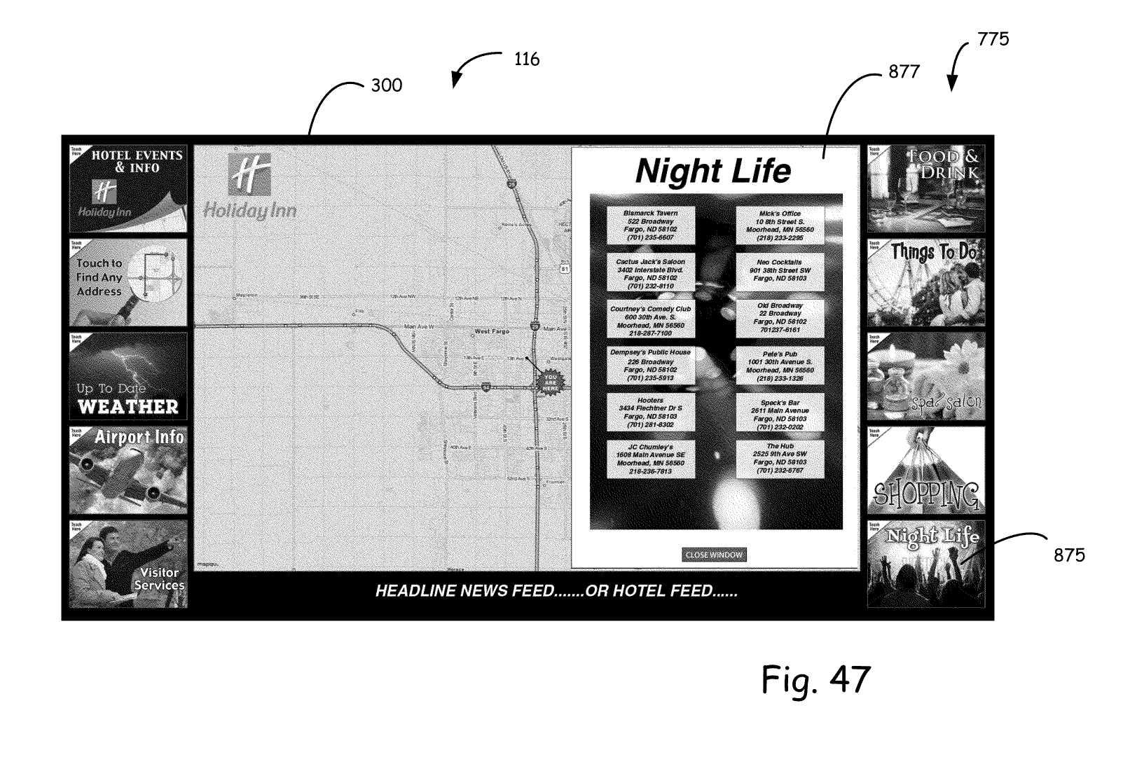

Referring finally to FIG. 47, shown as one of user inputs 775 is a NIGHT LIFE user input 875. When a user touches NIGHT LIFE user input 875, a NIGHT LIFE pop-up window 877 is displayed. NIGHT LIFE pop-up window 877 lists names and addresses of various local bars, comedy clubs, or other establishments and sources of entertainment.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Other examples of modifications of the disclosed concepts are also possible, without departing from the scope of the disclosed concepts.

What is claimed is:

1. A touch screen information system configured to provide guests or users of a hotel or business with information, the touch screen information system comprising:
system memory which stores an operating system, programming modules and program data;
a touch screen display device configured to provide a viewable area, capable of receiving a user input in the form of a touch, which includes a guest information display area and an operating system and administrative display area;
a bezel covering the operating system and administrative display area to prevent access to the operating system and administrative display area by guests or users of the hotel or business, but allowing access to the guest information display area by the guests or users of the hotel or business;
a processor operably coupled to the system memory and the touch screen display device such that the processor is configured with the operating system, programming modules and program data to control the touch screen display device to provide information to the guests or users of the hotel or business by displaying the information in the guest information display area.

2. The touch screen information system of claim 1, wherein the operating system and administrative display area is located in outer portions of the viewable area of the touch screen display device.

3. The touch screen information system of claim 2, wherein the bezel is removable by an administrator to allow access to the operating system and administrative display area.

4. The touch screen information system of claim 1, wherein the processor is configured to control the touch screen display device to provide information to the guests or users of the hotel or business by displaying a user interface (UI) in the guest information display area.

5. The touch screen information system of claim 4, wherein the UI includes a map showing an area surrounding a location of the hotel or business, a displayed location point on the map representing the physical location of the guest or user, a location icon displayed on the map indicating to the guest or user that the displayed location point is the physical location of the guest or user, and a displayed line connecting the location icon and the displayed location point, wherein the processor is configured to control the touch screen display device such that the guest or user can touch the location icon and drag the location icon to a different location on the map, and such that when the guest or user drags the location icon to a different location on the map the displayed location point does not move relative to the map and the displayed line moves or rotates to maintain the connection between the location icon and the displayed location point.

6. The touch screen information system of claim 4, wherein the UI includes local weather related information.

7. The touch screen information system of claim 6, wherein the UI includes a weather window which displays weather forecast information and weather radar information.

8. The touch screen information system of claim 4, wherein the UI includes user input category icons which allow the guest or user to select different categories of information to be displayed on the UI.

9. The touch screen information system of claim 8, wherein the category icons include icons for at least one of a food and drink category, a things to do category, a shopping category and a visitor services category.

10. The touch screen information system of claim 9, wherein the processor is configured to control the touch screen display device such that when a guest or user touches one of the category icons, local businesses or resources are displayed at locations on the map corresponding to locations of the local businesses or resources.

11. The touch screen information system of claim 4, wherein the processor is configured to control the touch screen display device to include in the UI a directions map and step-by-step directions from a location of the touch screen display device and a guest or user to a desired location.

12. The touch screen information system of claim 11, wherein the processor is configured to control the touch screen display device to include in the UI a find it now feature which allows a guest or user to obtain directions to any desired address.

13. The touch screen information system of claim 11, wherein the processor is configured to control the touch screen display device to include in the UI pop-up windows which are useable by the guest or user to have the touch screen information system text or email the directions to the user.

14. The touch screen information system of claim 4, wherein the wherein the processor is configured to control the touch screen display device to include in the UI airport information including at least one of aircraft arrival information, aircraft departure information, and directions to the airport.

15. The touch screen information system of claim 4, wherein the processor is configured to control the touch screen display device to include in the UI paid advertisement information from local businesses.
